(19) United States
(12) Patent Application Publication
(10) Pub. No.: US 2023/0261308 A1
(43) Pub. Date: Aug. 17, 2023

(54) THERMALLY CONDUCTIVE DIVIDER CONFIGURATION FOR BATTERIES

(71) Applicant: SABIC Global Technologies B.V., Bergen Op Zoom (NL)

(72) Inventors: Sreekanth Pannala, Sugar Land, TX (US); Nikhil K. E. Verghese, Richmond, TX (US); Remesh Kuzhikkali, Bangalore (IN)

(21) Appl. No.: 18/015,240

(22) PCT Filed: Jul. 9, 2021
(86) PCT No.: PCT/EP2021/069226

§ 371 Date: Jan. 9, 2023

(30) Foreign Application Priority Data
Jul. 10, 2020 (IN) 202041029452

(51) Int. Cl. H01M 50/293; H01M 10/653; H01M 50/209; H01M 10/0525; H01M 10/6556

(52) U.S. Cl. CPC H01M 50/293; H01M 10/653; H01M 50/209; H01M 10/0525; H01M 10/6556

(57) ABSTRACT

The present disclosure includes systems, devices, and methods of using a battery pack. The battery pack includes a plurality of cells and a divider. The plurality of cells includes a first cell and a second cell and a divider positioned between the first cell and the second cell and configured such that an in-plane conductivity of the divider is 0.1-100 watts per meter Kelvin, an in-plane conductivity of a cell is 1-100 watts per meter Kelvin, or a combination thereof. In some aspects, the divider may include a first surface configured to face the first cell and interposed between the first cell and the second cell and a second surface that extends from the first surface and faces the first cell and is interposed between the first cell and the third cell.

### TECHNICAL FIELD

The present disclosure relates generally to thermal/electrical/mechanical management of one or more battery power units, and more specifically, but not by way of limitation, to a battery and a battery divider for use with multiple, rechargeable batteries.

### BACKGROUND

Batteries are becoming increasingly used to power electronic and mechanical devices in, a wide range of applications, such as mobile phones, tablets, personal computers, hybrid electric vehicles, fully electric vehicles, and energy storage systems. Specifically, rechargeable batteries, such as Lithium-ion (Li-ion) batteries, have become popular due to several compelling features such as high power and energy densities, long cycle life, excellent storage capabilities, and memory-free recharge characteristics. Rechargeable batteries are designed to offer high power output and to be repeatedly charged and discharged for long-term use, as such, battery lifetime (e.g., total lifetime and lifetime per charge), battery stability, and battery size are imperative to battery design.

Some rechargeable batteries include a battery pack having several battery power units (e.g., cells) connected in series and/or parallel to create a battery pack with higher capacity and power output for larger, more demanding applications, such as electric vehicles. However, the amount of cells needed to output the desired power in high power applications may create several problems. For example, the higher amount of power units used in high powered battery packs increases the operational temperature of the battery packs. Most rechargeable batteries operate efficiently at room temperature (e.g., between 20-40° C.), and at temperatures outside of this range the capacity decreases rapidly and the batteries become prone to serious thermal hazards (e.g., shorts from a dendrite, overcharge). Batteries subjected to a mechanical crush/crash or penetration of a foreign object triggers a series of heat release events causing thermal runaway. Additionally, significant temperature variations can occur between individual power units in high power battery packs, resulting in an electrical imbalance. In some instances, to address heat concerns, current high power battery packs must be loosely packed such that they are overly cumbersome and excessively heavy. To address safety concerns from crash or foreign body intrusion, considerable protection has to be provided around the battery to ensure safe operation of the battery at the expense of increased weight, volume, and additional cost. Battery safety and lifetime are intimately connected to thermal/mechanical management of the cells, and current high power battery packs cannot provide effective heat transfer when closely packed and do not have suitable format to enable crash absorbing pack structures.

### SUMMARY

The present disclosure is generally related to systems, devices, and methods of temperature control of a battery pack having one or more battery power units. For example, an apparatus may include battery subpack. The battery subpack includes a plurality of cells including a first cell and a second cell; and a divider. The divider extends in a first plane and in a second plane different from the first plane, at least a portion of the divider positioned between the first cell and the second cell. An in-plane conductivity of the divider is between 0.1-100 watts per meter Kelvin; an in in-plane conductivity of a cell of the plurality of cells is between 1-100 watts per meter Kelvin; or a combination thereof. In some implementations, the plurality of cells further includes a third cell, and the divider includes a first surface configured to face the first cell and interposed between the first cell and the second cell; and a second surface that extends from the first surface and faces the first cell, and interposed between the first cell and the third cell.

In some implementations of the present systems, devices, and methods, an apparatus may include a battery subpack. The battery subpack includes a plurality of cells including a first cell and a second cell. The plurality of cells is interposed between a first side and a second side of a battery subpack, the second side opposite the first side. The battery subpack also includes a divider. The divider extends in a first plane and in a second plane different from the first plane, at least a portion of the divider positioned between the first cell and the second cell. The plurality of cells are configured such that an instantaneous variation of the battery subpack is less than or equal to 10 degrees Celsius while operating at an overall temperature within a range of 20-40 degrees Celsius and while the plurality of cells unload at a C rate of 2 for 25% capacity discharge. In some implementations, the plurality of cells further includes a third cell, and the divider includes a first surface configured to face the first cell and interposed between the first cell and the second cell; and a second surface that extends from the first surface and faces the first cell, the second surface interposed between the first cell and the third cell.

In some implementations of the present systems, devices, and methods, an apparatus may include a battery subpack. The battery subpack includes a plurality of cells including a first cell and a second cell, the plurality of cells interposed between a first side and a second side of a battery subpack, the second side opposite the first side. The battery subpack also includes a divider that extends in a first plane and in a second plane different from the first plane, at least a portion of the divider positioned between the first cell and the second cell. The plurality of cells are configured such that an instantaneous variation of the battery subpack is within +/−20 degrees Celsius of an ambient temperature while the plurality of cells unload at a C rate of 2 for 25% capacity discharge. In some implementations, the plurality of cells may include a third cell, and the divider may include a first surface configured to face the first cell and interposed between the first cell and the second cell; and a second surface that extends from the first surface and faces the first cell, the second surface interposed between the first cell and the third cell.

In some implementations of the present systems, devices, and methods, an apparatus may include a battery subpack. The battery subpack includes a plurality of cuboid cells including a first cuboid cell and a second cuboid cell. The plurality of cuboid cells are positioned within a cuboid case. The cuboid case may include a horizontal cross-section through the plurality of the cells where the plurality of cells include at least 50 percent of a total area of the horizontal cross-section. In some implementations, the plurality of cells include at least 80 percent of the horizontal cross-section. In an alternative implementation, the plurality of cells may be arranged to form a structure other than a cuboid.

In some implementations of the present systems, devices, and methods, an apparatus may include a battery subpack. The battery subpack includes a plurality of cells including a first cell, a second cell, a first side, and a second side opposite the first side. The battery subpack also includes one or more dividers positioned between the first side and the second side. The one or more dividers extend in a first plane and in a second plane different from the first plane, at least a portion of the one or more divider positioned between the first cell and the second cell. The battery subpack further includes a plate disposed on the second side of the plurality of cells. In some implementations, the plurality of cells may include a third cell, and the one or more dividers including a first surface configured to face the first cell and a second surface configured to extend from the first surface and face the first cell. The first surface interposed between the first cell and the second cell, and the second surface interposed between the first cell and the third cell.

In one or more of the foregoing apparatuses, the first surface and the second surface of the divider cooperate to form a single unitary divider.

In one or more of the foregoing apparatuses, the first surface corresponds to a first divider, and the second surface corresponds to a second divider that is interlockingly coupled to the first divider.

In one or more of the foregoing apparatuses, each cell of the plurality of cells is a lithium-ion battery

In one or more of the foregoing apparatuses, the battery subpack further includes a plate disposed on a second side of the plurality of cells. Additionally, or alternatively, the plurality of cells include and are interposed between the first side and the second side opposite the first side.

In one or more of the foregoing apparatuses, the divider includes a material selected from the group including fiber, carbon fiber, highly oriented polyolefins, a polymer, metalized polymers, and a highly conductive metal.

In one or more of the foregoing apparatuses, the divider includes a polymer, the divider defines a liquid channel, or a combination thereof.

In one or more of the foregoing apparatuses, the divider includes a plurality of fibers, and fiber of the plurality of fibers includes a first end positioned on the first side of the plurality of cells and a second end positioned on the second side of the plurality of cells.

In one or more of the foregoing apparatuses, the plate includes a first planar surface and a second planar surface interposed between the first surface and the plurality of cells.

In one or more of the foregoing apparatuses, the horizontal cross section is parallel to the second planar surface of the plate.

In one or more of the foregoing apparatuses, the one or more dividers are further configured to surround each cell of the plurality of cells.

In one or more of the foregoing apparatuses, the portion of the at least one cell surrounded by the one or more dividers is positioned proximate to the second side of the one or more cells.

In one or more of the foregoing apparatuses, the one or more dividers extend from the first side of the plurality of cells and the second side of the plurality of cells.

In one or more of the foregoing apparatuses, the one or more dividers include a first divider having a first surface facing the first cell of the plurality of cells, and a second divider having a second surface facing the first cell, the second surface orthogonal to the first surface. In some implementations, the first divider is interposed between the first cell and the second cell of the plurality of cells.

In one or more of the foregoing apparatuses, the plate includes a first surface and a second surface interposed between the first surface and the plurality of cells; and the one or more dividers include a first divider having a third surface orthogonal to the second surface of the plate.

In one or more of the foregoing apparatuses, the plurality of cells are configured such that a temperature differential between the first side and the second side of each cell does not exceed 5 degree Celsius per inch while the plurality of cells unload at a C rate of 2 for 25% capacity discharge.

In one or more of the foregoing apparatuses, the plate defines one or more channels. In some implementations, the battery subpack further includes a liquid positioned within the one or more channels.

In one or more of the foregoing apparatuses, each cell of the plurality of cells includes a negative terminal and a positive terminal disposed on an end of the cell.

In one or more of the foregoing apparatuses, the first cell of the plurality of cells includes a first busbar positioned on a first side of the first cell, and a second busbar positioned on a second side the first cell, that is opposite the first side of the first cell, or a combination thereof. The first busbar, the second busbar, or both may be configured to be thermally and/or electrically conductive.

As used herein, various terminology is for the purpose of describing particular implementations only and is not intended to be limiting of implementations. For example, as used herein, an ordinal term (e.g., “first,” “second,” “third,” etc) used to modify an element, such as a structure, a component, an operation, etc., does not by itself indicate any priority or order of the element with respect to another element, but rather merely distinguishes the element from another element having a same name (but for use of the ordinal term). The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, and 10 percent.

The term “about” as used herein can, allow for a degree of variability in a value or range, for example, within 10%, within 5%, or within 1% of a stated value or of a stated limit of a range and includes the exact stated value or range. The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed implementation, the term “substantially” may be substituted with “within [a percentage] of” what is specified, where the percentage includes 0.1, 1, or 5 percent; and the term “approximately” may be substituted with “within 10 percent of” what is specified. The statement “substantially X to Y” has the same meaning as “substantially X to substantially Y,” unless indicated otherwise. Likewise, the statement “substantially X, Y, or substantially Z” has the same meaning as “substantially X, substantially Y, or substantially Z,” unless indicated otherwise. The phrase “and/or” means and or or. To illustrate, A, B, and/or C includes: A alone, B alone, C alone, a combination of A and B, a combination of A and C, a combination of B and C, or a combination of A, B, and C. In other words, “and/or” operates as an inclusive or. Additionally, the phrase “A, B, C, or a combination thereof” or “A, B, C, or any combination thereof” includes: A alone, B alone, C alone, a combination of A and B, a combination of A and C, a combination of B and C, or a combination of A, B, and C.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The terms “comprise” (and any form of comprise, such as “comprises” and “comprising”), “have” (and any form of have, such as “has” and “having”), and “include” (and any form of include, such as “includes” and “including”) are open-ended linking verbs. As a result, an apparatus that “comprises,” “has,” or “includes” one or more elements possesses those one or more elements, but is not limited to possessing only those one or more elements. Likewise, a method that “comprises,” “has,” or “includes” one or more steps possesses those one or more steps, but is not limited to possessing only those one or more steps.

Any implementation of any of the systems, methods, and article of manufacture can consist of or consist essentially of—rather than comprise/have/include—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb. Additionally, the term “wherein” may be used interchangeably with “where”. Further, a device or system that is configured in a certain way is configured in at least that way, but it can also be configured in other ways than those specifically described. The feature or features of one implementation may be applied to other implementations, even though not described or illustrated, unless expressly prohibited by this disclosure or the nature of the implementations.

Some details associated with the implementations are described above, and others are described below. Other implementations, advantages, and features of the present disclosure will become apparent after review of the entire application, including the following sections: Brief Description of the Drawings, Detailed Description, and the Claims.

### BRIEF DESCRIPTION OF THE DRAWINGS

The following drawings illustrate by way of example and not limitation. For the sake of brevity and clarity, every feature of a given structure is not always-labeled in every figure in, which that structure appears. Identical reference numbers do not necessarily indicate an identical structure. Rather, the same reference number may be used to indicate a similar feature or a feature with similar functionality, as may non-identical reference numbers.

FIG. 1A is a perspective view of an example of the present battery subpack.

FIG. 1B is a top, cross-sectional view of the battery subpack of FIG. 1A along line 1B-1B.

FIG. 2A is a perspective view of another example of a battery subpack with a plurality of dividers.

FIG. 2B is a top, cross-sectional view of the battery subpack of FIG. 2A along line 2B-2B.

FIG. 2C is a top, cross-sectional view of another example of a battery subpack.

FIG. 2D is a top, cross-sectional view of another example of a battery subpack.

FIG. 2E is a top, cross-sectional view of another example of a battery subpack.

FIG. 3 is a perspective view of another example of a battery subpack.

FIG. 4A is a side view of a battery of a thermal and crash management system.

FIG. 4B is a top, cross-sectional view of the battery of FIG. 4A

FIG. 5A is a perspective view of an alternative battery of the present thermal management system.

FIG. 5B is atop cross-sectional view of the battery of FIG. 5A.

FIG. 6 is a flowchart of an example of a method of operating a battery subpack.

FIGS. 7A and 7B are top and perspective views, respectively of a battery subpack of the present thermal management system used in a thermal simulation.

FIG. 8A is an illustrative model of a temperature profile of an exterior of the battery subpack of FIG. 7A during a first temperature simulation.

FIG. 8B is an illustrative model of a temperature profile of cross-sections of the battery subpack of FIG. 8A

FIG. 8C is an illustrative model of a temperature profile of three cells of the battery subpack of FIG. 8A

FIG. 8D is a graph showing the maximum temperatures of the battery subpack of FIG. 8A at the three locations with respect to time.

FIG. 9A is an illustrative model of a temperature profile of an exterior of the battery subpack of FIG. 7A during a second temperature simulation.

FIG. 9B is an illustrative model of a temperature profile of cross-sections of the battery subpack of FIG. 9A

FIG. 9C is an illustrative model of a temperature profile of three cells of the battery subpack of FIG. 9A

FIG. 9D is a graph showing the maximum temperatures of the battery subpack of FIG. 9A at the three locations with respect to time.

FIG. 10 Energy density and specific energy at system level vs. Energy density and specific energy at system level (From: Löbberding et al., From Cell to Battery System in BEVs: Analysis of System Packing Efficiency and Cell Types, World Electric Vehicle Journal, 2020)

FIG. 11 Square cross-section cells arranged into metal plastic hybrid lattice structure to result in 70% system level energy density as compared to cell energy density

FIG. 12 Temperature at the end of the discharge (30 minutes) with a constant 2 C discharge with the coolant temperature of 27° C. Fig. a) Contours of temperature in the battery pack; b) Temperature contours on the mid-planes

FIG. 13 Hexagonal cross-section cells arranged into metal plastic hybrid lattice structure to result in 60-70% system level energy density as compared to cell energy density

### DETAILED DESCRIPTION

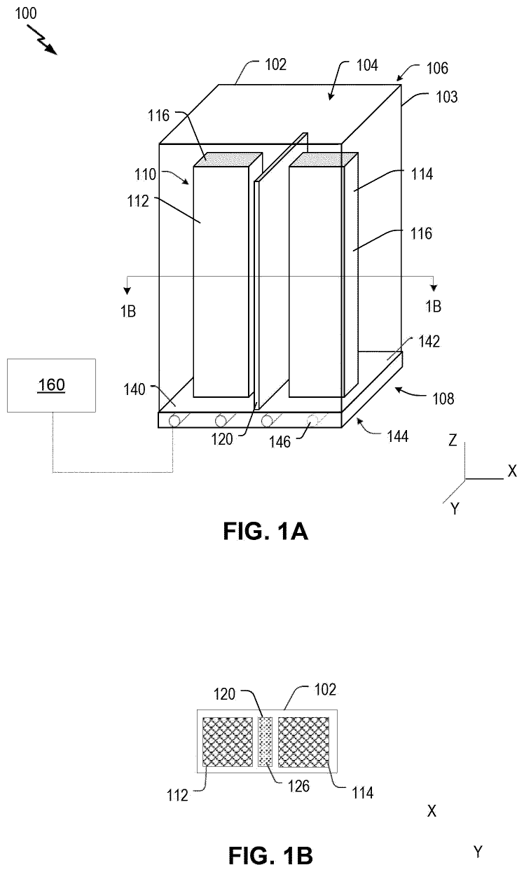

Referring to FIGS. 1A and 1B, illustrative views of a battery subpack 100 are shown. For example, FIG. 1A shows a perspective view of a battery subpack 100. By way of illustration, battery subpack 100 may be described with reference to a right handed coordinate system, as shown in FIG. 1A, in which the x-axis corresponds to a left-right direction of the page, the Z-axis corresponds to, an up-down direction on the page, and the Y-axis corresponds to an axis that travels orthogonally into the page. As depicted in FIG. 1A, battery subpack 100 includes a case 102, a plurality of cells 110, a first divider 120, and a plate 140.

As shown, cells 110 include a first cell 112 and a second cell 114. Cells 110 may be a rechargeable, or secondary, cell that can be discharged and recharged multiple times. For example, first cell 112 and second cell 114 may be lithium-ion batteries. As shown, cells 110 include a cover 116 that can define a chamber in which one or more internal components of the cells are disposed. For example, cells 110 may include one or more internal components such as, for example, one or more busbars, one or more current collectors, one or more separators, an anode, a cathode, or combination thereof. Cells 110 may be prismatic, cylindrical, or other suitable shapes. In some implementations, first cell 112 and second cell 114 are shaped as a cuboid and may be may be arranged in rows, as shown, so that cells 110, 112 may be positioned in close proximity to provide a maximum number of cells in battery subpack 100. While FIG. 1A shows two cells, battery subpack 100 may include more than two cells arranged in rows and columns so that that the cells may be positioned in close proximity to provide a maximum number of cells in battery subpack 100. By arranging cells in rows and/or columns, a high number of cells may be provided to increase the power output of a battery subpack 100.

In some implementations, cells 110 are, interposed between a first side 106 and a second side 108 of battery subpack 100, the second side being opposite the first side. For example, cells 110 may be disposed within case 102. Case 102 may include one or more walls 103 that cooperate to define a cavity 104.

Case 102 may include a rigid, semi-rigid, or flexible material and may operate to separate cells 110 from the outside environment. In this way, cells 110 may be shielded from outside contaminants and allow for safe handling of battery subpack 100. As shown, case 102 is shaped similar to cells 110 (e.g., cuboid) so that a maximum number of the cells may be arranged within the case. In some implementations, case 102 may include a thermally conductive material. In this manner, case 102 may assist to facilitate the thermal management of battery subpack 100 at least by distributing (or dissipating) heat generated by cells 110.

In some implementations, case 102 includes plate 140. For example, plate 140 may define or be positioned on second side 108 of case 102. Plate 140 includes first surface 142 and second surface 144 that is opposite the first surface. In some implementations, plate 140 may be coupled to walls 103 and/or cells 110. For example, walls 103 and/or cells 110 may be disposed on top of first surface 142. As shown, 140 is rectangular, however, the plate may be sized or shaped in any suitable manner

First divider 120 is positioned between first cell 112 and second cell 114. First divider 120 may be sized, positioned, and comprised of a materials, as described herein, to provide thermal insulation between the cells to prevent cell-to-cell propagation of thermal event, enable high in-plane conductivity to distribute (or dissipate) the heat across the divider but also the cooling plate at the bottom, provide structural integrity by spreading the impact of a mechanical intrusion of a foreign object or crash, or a combination thereof. In some implementations, the thermal conductivity of first divider 120 is greater than or substantially equal to any one of, or between any two of 0.1, 5, 10, 15, 20, 25, 30, 35, 40, 45, 50, 55, 60, 65, 50, 55, 80, 85, 90, 95, 100, 110, or 120 watts per meter Kelvin (“W/(mK)”). The thermal conductivity may be measured along a plane (e.g., X, Y, or Z plane). For example, the in-plane conductivity of first divider 120 can be greater than or equal to 10 watts per meter Kelvin and less than or equal to 100 watts per meter Kelvin. In some implementations, first divider 120 is in contact with first and second cell 112, 114, however, in other implementations, the first divider is positioned adjacent to the cells to enable the first divider to effectively remove heat from the cells. As shown, first divider 120 extends along an entirety of one side of first cell 112 and second cell 114 to maximize the area of heat transfer between the first divider and the first and second cell. First divider 120 is disposed within cavity 104 and may extend along an entirety of the cavity.

First divider 120 is interposed between first cell 112 and second cell 114 and configured to distribute the heat produced by the cells in at least a first direction corresponding to the Z-axis (e.g., height of cells). In some such implementations, first divider 120 includes a plurality of fibers oriented in the first direction such that heat distributing from the first end of the fiber to the second end of the fiber is also distributing in the first direction. In some implementations, first divider 120 may distribute heat in a second direction corresponding to a length of the first divider (e.g., along the Y-axis). In some implementations, first divider 120 may surround more than one side of or completely surround first cell 112 and/or second cell 114 to distribute heat from the cells. For example, first divider 120 may extend in a first plane and in a second plane different from the first plane. Additionally, or alternatively, first divider 120 may include a single, unitary divider or one or more dividers, such as a first divider and a second divider that are independent or coupled. For example, the first divider and the second divider may be interlocking coupled.

First divider 120 may also prevent cell-to-cell propagation during a thermal event (e.g., thermal runaway) at one of the cells (e.g., 112). To illustrate, first divider 120 may include a flame resistant material that acts as a firewall between the first and second cells 112, 114. In an illustrative implementation, first divider 120 includes fibers with flame resistant properties. In this way, failure at one cell may be contained and total destruction of battery subpack 100 may be prevented.

In the depicted implementation, first divider 120 extends from plate 140 (e.g., second side 108) toward first side 106. First divider 120 and plate 140 may facilitate heat transfer from cells 110 during operation of battery subpack 100. In some implementations, first divider 120 and/or plate 140 may include a thermally conductive material such as, for example, a polymer, metalized polymers, composite, fiber-reinforced composite (e.g., carbon fiber), or the like. First divider 120 may be the same or a different material as plate 140. Additionally, or alternatively, first divider 120 and plate 140 may be separate components and coupled together. However, in alternative implementations, first divider 120 and plate 140 are integrally formed as one component. First divider 120 and plate 140 may prevent mechanical, impact of the cell or operate to distribute energy away from first and second cells 112, 114. For example, first divider 120 and plate 140 may operate in, conjunction to minimize energy transferred to the cells based on an impact of the battery subpack 100.

Additionally, during operation, plate 140 may distribute heat in a direction orthogonal to the first direction. For example, plate 140 may be coupled to first divider 120 such that the plate and the first divider are orthogonal, and the plate may transfer heat from the first divider in the second direction. Plate 140 may transfer heat along the X-axis, Y-axis, or any direction in the X-Y plane.

In some implementations, plate 140 and/or first divider 120 may include one or more cooling features to maintain a desired temperature during operation of cells 110. For example, plate 140 may, but need not, define one or more channels 146 that are configured to be filled with a fluid. Channels 146 are configured to carry a fluid through plate 140 to increase the heat transfer from cells 110. In some implementations, channels 146 may transport air, a gas, water, deionized water, glycol/water solutions, dielectric fluids (e.g., fluorocarbons or Polyalphaolefin (PAO)), or combination thereof. As shown, channels 146 extend along the Y-axis, however other implementations of plate 140 may define channels that extend along the X-axis or any other direction in the X-Y plane. In some implementations, first divider 120 includes a plurality of fibers 126, each of which may be oriented such that they extend from first side 106 to second side 108 (e.g., along z-axis). In other implementations, fibers 126 may be oriented along y-axis or any other orientation to provide efficient heat transfer from cells 110. Although not shown, in some implementations, plate 140 may include a plurality of fibers (e.g., 126) and divider 120 may include one or more channels (e.g., 146).

In some implementations, battery subpack 100 may include or be coupled to a pump 160. Pump 160 may be any suitable positive or negative pressure source and is configured to enable fluid to flow through channels 146. In some implementations, pump 160 may be coupled to a liquid reservoir or another fluid source to circulate fluid through plate 140 and/or dividers (e.g., 120). It is noted that in other implementations, the battery subpack 100 may not include or be coupled to a pump. For example, the channels 146 may defined a closed system in which air or a liquid moves or circulates within the closed system based on changes in temperature.

Battery subpack 100 enables heat in one or more cells 110, 112 to be distributed by first divider 120 and/or plate 140. In this way and others, first divider 120 and plate 140 may regulate the temperature among the cells 110 and decrease an overall operational temperature of battery subpack 100. For example, first divider 120 and/or plate 140 may be arranged and configured such that a temperature differential between first side 106 and second side 108 of battery subpack 100 does not exceed 1 degree Celsius per inch during operation of battery subpack 100 (e.g., while the first and second cells unload at a C rate of 2). In some implementations, first divider 120 and/or plate 140 may distribute heat produced by cells 110 such that the temperature differential along the height of the cells (e.g., between first side 106 and second side 108) does not exceed 1 degree Celsius per inch during operation of the cells up to a C-rate of 5.

In some implementations, the plurality of cells are configured such that an instantaneous variation of the battery subpack is within 4 degrees Celsius while the plurality of cells unload at a C rate of 2. For example, in some implementations, during charge or discharge of the plurality of cells, a battery subpack may be configured to operate within a range of 20-40° C. At temperatures above 40° C., the battery subpack can experience accelerated aging. Additionally, at 70° C. and above, an increased risk of thermal runaway, fire, venting, or a combination thereof may be present. At temperatures below 20° C., a battery subpack may experience reduced power capacity. Additionally, at 0° C. and below, the battery subpack can experience lithium plating, dendrite formation, and low charging. During operation of the battery subpack within the range of 20-40° C., such as when at a C rate of 2, the battery subpack may be configured to have a temperature difference, such as an inter-cell temperature difference of less than or equal to 4° C., such as less than or equal to 3° C. To illustrate, a difference between a minimum temperature and a maximum temperature of the plurality of cells at the same time may be less than or equal to 4° C. In other implementations, during charge or discharge of the plurality of cells a difference between a minimum temperature and a maximum temperature of the plurality of cells at the same time may be less than or equal to 3 or 2° C. Operation of the battery subpack within such a temperature difference may reduce or prevent a pack charge imbalance of the battery subpack.

Referring now to FIG. 1B, a top, cross-section view of the battery subpack 100 about line 1B-1B is shown. In some implementations, in a horizontal cross section of case 102, cells 110 may define a majority (e.g., 50-95%) of the area of case 102. For example, in a cross section taken about a first plane lying in the X-Y axes, cells 110 may define greater than or substantially equal to any one of, or between any two of: 25, 30, 35, 40, 45, 50, 55, 60, 65, 50, 55, 80, 85, 90, or 95 percent of the total area of the cross-section of case 102 taken about the first plane. In such implementations, a higher percentage of total area may correspond to densely packed cells with good thermal distribution, while the lower percentage of total area may allow for air cooling or other ways to manage heat.

As shown, a single battery subpack 100 is configured to provide power to an external device; however, multiple subpacks 100 may be connected to increase the power provided. In some implementations, battery subpacks 100 may be stackable with one or more other rectangular battery packs (e.g., 100) to comply with space limitations and/or power requirements of a desired application. For the sake of clarity, one or more other components of battery subpacks 100 are not shown herein, however, battery subpack may include a circuit board, processor, controller, wiring, conductor, resistor, terminal block, electrode terminals, and/or the like.

A battery subpack 100 includes a plurality of cells, such as first cell 112 and second cell 114. Battery subpack 100 further includes a divider 120 positioned between the first cell 112 and the second cell 114 and configured such that an in-plane conductivity of the divider 120 is greater than or equal to 0.1 watts per meter Kelvin and less than or equal to 100 watts per meter Kelvin (e.g., 10-80 watts per meter Kelvin). In some implementations, divider 120 extends in a first plane and in a second plane different from the first plane.

In some implementations of battery subpack 100 the plurality of cells, such as first cell 112 and second cell 114, may be interposed between first side 106 and second side 108 opposite first side 106. The plurality of cells may be configured such that a temperature differential between the first side 106 and the second side 108 does not exceed 1 degree Celsius per inch while the plurality of cells unload at a C rate of 2.

In some implementations of battery subpack 100, the plurality of cells may include a plurality of cuboid cells such as first cell 112 shaped as a cuboid and second cell 114 shaped as a cuboid. The plurality of cuboid cells may be arranged to form a cuboid with a horizontal cross-section. In some implementations, the plurality of cuboid cells 110, 112 define at least 50-95 percent of the horizontal-cross section.

In other implementations of battery subpack 100, the plurality of cells 110, such as a first cell 112 and a second cell 114 include a first side 106 and a second side 108 opposite the first side 106. The battery subpack 100 may include one or more dividers 120 positioned between the first side 106 and the second side 108. The one or more dividers 120 may surround at least a portion of at least one cell of the plurality of cells 110, 112, 114. The battery subpack 100 may also include a plate 140 disposed on the second side 108 of the plurality of cells 110. In some implementations, the one or more dividers 120 extend in a first plane and in a second plane different from the first plane.

In the foregoing implementations, first divider 120 and plate 140 operate to efficiently remove heat distributed from first cell 112 and second cell 114 and maintain substantially uniform temperatures across battery subpack 100. Plate 140 may be orthogonal to first divider 120 such that heat may be distributed from cells 110 along a first plane and a second plane that is orthogonal to the first plane. In this way and others, heat may be removed along the X, Y, and Z-axes during operation of battery subpack 100. In some implementations, cells 110 (e.g., first cell 112 and second cell 114) may be shaped as cuboids and arranged in rows and columns to enable close packing of cells with minimal loss of volume and/or additional dead weight. In such implementations, first divider 120 and plate 140 may be shaped as rectangular prisms to enable efficient packing of cells 110 and increase pack-level energy density while providing an effective way to remove heat from the cells. Accordingly, battery subpack 100 may be able to increase energy density and regulate the temperature of cells (e.g., 110) without limiting performance of the cells and minimizing the risk of serious thermal hazards.

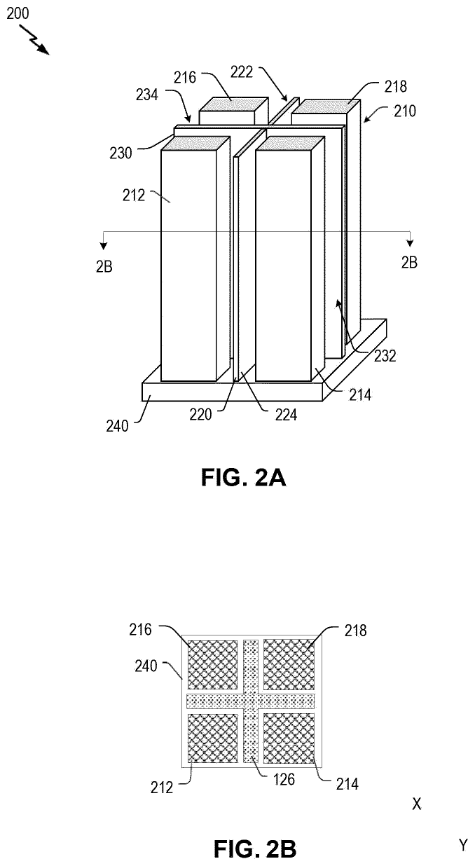

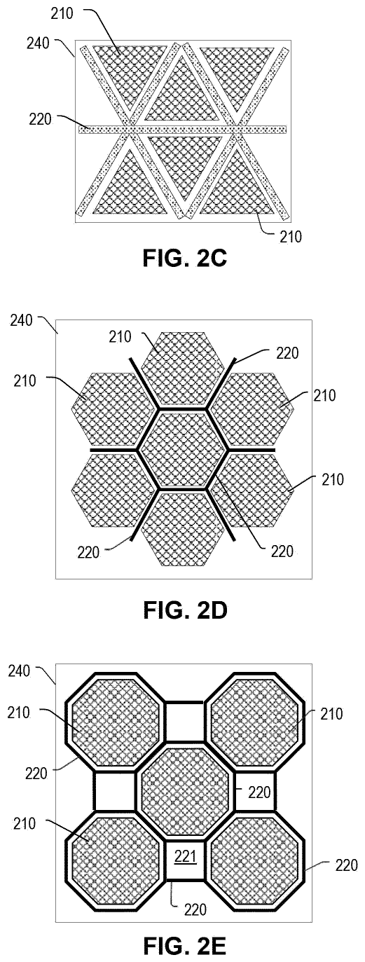

Referring to FIGS. 2A and 2B, a battery subpack 200 with a plurality of dividers (e.g., 120, 220) is shown. For example, FIG. 2A shows a perspective view of battery subpack 200 and FIG. 2B shows a top cross-sectional view of the battery subpack along lines 2B-2B. Battery subpack 200 includes a plurality of cells 210, a first divider 220, and second divider 230. Battery subpack 200 may operate similar to battery subpack 100 and can include one or more features of battery subpack 100.

As shown in FIGS. 2A and 2B, cells 210 include a first cell 212, a second cell 214, a third cell 216, and a fourth cell 218. Each cell 210 may be coupled together such that the power generated by each cell may be delivered to a single external device. Cells 210 may be prismatic (e.g., cuboid) and arranged in rows and/or columns, or can be another configuration or pattern, to provide a maximum number of cells in a battery subpack 200.

First divider 220 may be positioned between first cell 212 and second cell 214. First divider 220 may include or correspond to first divider 120. First divider 220 may include a first divider surface 222 and a second divider surface 224. First divider 220 may cover a single side of at least one of the cells (e.g., 210), yet, in other implementations, the first divider 220 may cover more than one side (e.g., surround) of at least one of the cells. As shown in FIG. 2A, first divider surface 222 faces first cell 212 and second divider surface 224 is opposite of the first divider surface and faces second cell 214. In some implementations, first divider 220 extends along an entire column of cells 210. In such implementations, first divider surface 222 faces a first column (e.g., first cell 212 and third cell 216) and second divider surface 224 faces a second column (e.g., second cell 214 and fourth cell 218).

Second divider 230 may be coupled to or unitary with first divider 220. First divider 220 and second divider 230 may be angularly disposed relative to one another such that the first divider extends in a first plane (e.g., first vertical plane) and the second divider extends in a second plane (e.g., second vertical plane) that is different from the first plane. As shown, first divider 220 and second divider 230 are angularly disposed relative to each other by an angle of approximately 90 degrees, however, the angle may be more or less than 90 degrees (e.g., between 5 and 85 degrees or between 95 and 175 degrees), as described herein. In some implementations, second divider 230 includes a third divider surface 232 and a fourth divider surface 234 that is opposite of the third divider surface. Second divider 230 may be positioned between two or more adjacent cells 210 to remove heat from the adjacent cells. In some implementations, second divider 230 may be parallel to first divider 220 and be spaced from the first divider such that one or more cells are disposed between the first and second dividers. In other implementations, such as the implementation depicted in FIG. 2A, second divider 230 is angularly disposed relative to first divider 220. For example, second divider 230 may be positioned orthogonal to first divider 220. In some implementations, second divider 230 may extend partially or along an entire row of cells 210. To illustrate, third divider surface 232 faces a first row (e.g., first cell 212 and second cell 214) and fourth divider surface 224 faces a second row (e.g., third cell 216 and fourth cell 218). A portion of first divider 220 or second divider 230 may be interposed between any two cells of the plurality of cells 210. In this way, each cell 210 may be separated from one other cell of the plurality of cells by a divider (e.g., 220, 230). Although only four cells (e.g., 210) and two dividers (e.g., 220, 230) are shown, some implementations include five or more cells (e.g., 210) and/or three or more dividers. While described as single cells, the first, second, third, and fourth cells 212, 214, 216, 218, each cell may include a plurality of cells (e.g., 2 cells, 4 cells, or the like) coupled together and operate in a similar manner as described above.

Second divider 230 may be coupled to (e.g., intersect) first divider 220. For example, first and second divider 220, 230 may be separate, discrete components or can be a single unitary structure. To illustrate, although described as first divider 220 and second divider 230, it should be noted that the first and second dividers may cooperate to form a single divider that, for example, includes first divider surface 222, second divider surface 224, third divider surface 232, and a fourth divider surface 234. First and second dividers 220, 230, may be integrally formed with or interlocked with one or more other dividers to protect and transfer heat away from cells 210. In other implementations, first and second divider 220, 230 are not in contact with each other.

Each of first divider 220 and second divider 230 may be disposed on a plate 240. Plate 240 may include or correspond to plate 140. In some implementations, first divider 220 and/or second divider 230 are orthogonal to plate 240. For example, first divider 220, second divider 230, and plate 240 are each in contact with and orthogonal to each other to transfer heat in along a separate axis. In this way and others, heat produced during operation of cells 210 may be distributing along three separate planes to maintain substantially uniform temperatures across a battery subpack 200. First divider 220, second divider 230, and/or plate 240 may, but need not include fibers and/or define one or more channels configured to transport fluid to facilitate in heat distribution.

Referring to FIGS. 2C, 2D, and 2E, battery subpack 200 need not be square, but can have any suitable cross-sectional shape (e.g., triangular, rectangular, pentagon, hexagonal, octagonal, circular, elliptical, or otherwise polygonal or rounded). For example, FIG. 2C shows a battery subpack 200 with a plurality of triangular cells 210, FIG. 2D shows a battery subpack 200 with a plurality of hexagonal cells 210, and FIG. 2E shows a battery subpack 200 with a plurality of octagonal cells 210.

The cross-sectional shape of the cells may be selected based on the specific application of battery subpack 200. In this way, battery subpack 200 gives the flexibility to pack cells 210 more densely than conventional cylindrical or rectangular cells. As shown, a plurality of dividers 220 are positioned between each adjacent cell 210. In some implementations, dividers 220 may be positioned around a perimeter (e.g., a cross-sectional perimeter) of one or more cells 210, such as around all the cells 210. The dividers 220 cooperate to define a chamber in which the polygonal cells may be placed. As shown, the chamber defined by the cooperating dividers (e.g., 220) has the same cross-sectional shape as cells 210 (e.g., triangular in FIG. 2C, hexagonal in FIG. 2D, octagonal in FIG. 2E) to enable battery subpack 300 to be densely packed. For example, each dividers 220 may be substantially parallel to an exterior wall of cell 210. In such implementations, heat may be distributed in a direction orthogonal to the exterior wall of cell 210 to increase thermal regulation of the cells. However, in other implementations, the chamber may have a different cross-sectional shape than that of the cells. Referring to FIG. 2E, a cavity 221 may be defined by one or more dividers 220. Additionally or alternatively, a cavity (e.g., 221) may be defined by dividers 220, container 240, one or more cells 210, or combination thereof. The cavity 221 may be filled with air, a gas, a liquid, a phase change material (PCM), or a combination thereof. Additionally, or alternatively, cavity 221 may be at least partially filed with a material, such as the same material as dividers 220, and the material may be solid, mesh, honeycomb, or another configuration.

The plurality of cells 210 and dividers 220 may be disposed within container 240. Container 240 is shown as having a rectangular shape, the container may include a same, or different, cross-sectional shape as cells 210 (e.g., triangular, rectangular, pentagon, hexagonal, octagonal, circular, elliptical, or otherwise polygonal or rounded). In some implementations, container 240 may include a conductive material to distribute heat from dividers 220 and cells 210. Additionally, or alternatively, container 240 and/or dividers 220 may distribute energy from an impact to battery subpack 200 to reduce damage to cells from the impact. In some implementations, cells 210 may be compressible so energy is distributed to container 240 and/or dividers 220 rather than focused at the cells. This may prevent thermal runaway due to impacts occurring at battery subpack 200.

In some implementations, dividers 220 may include several separate interlocking components, while, in other implementations, the dividers may cooperate to form a single unitary structure. In some implementations, each divider (e.g., 220) is disposed in a separate vertical plane that is different from the other dividers. Additionally, or alternatively, dividers 220 may be integrally formed with container 240. However, in some implementations, dividers 220 and container 240 are separate components that may be coupled together.

Although only a single battery subpack (e.g., 200) is shown. Two or more battery subpacks may be physically and or electrically coupled together to form a system that is can generate more power. In such implementations, each battery subpack (e.g., 200) of the system may be spaced apart from the other battery subpacks. In some implementations, some of the battery subpacks may be separated by dividers that may include some of the same features as dividers 200 (e.g., material, fibers, channels, and/or the like). The dividers placed between the battery subpack can have differing properties (e.g., thermal conductivity) to manage the heat in the system.

In some of the foregoing implementations, battery subpack 200 includes a plurality of cells 210 including a first cell 212, a second cell 214, and/or a third cell 216. Battery subpack 200 may include a divider that extends in a first plane and in a second plane different from the first plane, at least a portion of the divider positioned between the first cell and the second cell. Additionally, or alternatively, at least one other portion of the divider is positioned between the first cell and the third cell. In some implementations, divider includes a first surface 222 facing first cell 212 and a second surface 232 extending from the first surface and facing the first cell, where the first surface is interposed between the first cell and second cell 214 and the second surface is interposed between the first cell and third cell 216. In some such implementations, the divider 220, 230 includes an in-plane conductivity of that is between 0.1-100 watts per meter Kelvin.

In some implementations, battery subpack 200 may include a plurality of cells 110 interposed between a first side (e.g., 106) and a second side (e.g., 108) the second side opposite the first side and a divider that extends in a first plane and in a second plane different from the first plane, at least a portion of the divider positioned between the first cell and the second cell. Additionally, or alternatively, at least one other portion of the divider is, positioned between the first cell and the third cell. In some implementations, divider includes a first surface 222 facing first cell 212 and a second surface 232 extending from the first surface and facing the first cell, where the first surface is interposed between the first cell and second cell 214 and the second surface is interposed between the first cell and third cell 216. In some implementations, the plurality of cells are configured such that a temperature differential between the first side and the second side does not exceed 1 degree Celsius per inch while the plurality of cells unload at a C rate of 2. Battery subpack 200 may include a plate disposed on the second side (e.g., 108) of the plurality of cells 110.

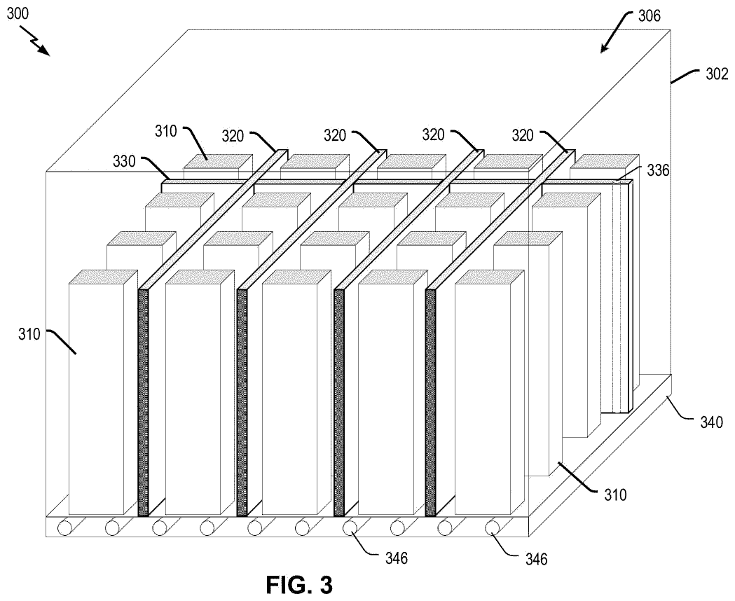

Referring to FIG. 3, a perspective view of a battery subpack 300 with a plurality of cells 310 and a plurality of dividers (e.g., 320, 330) is shown. As shown, cells 310 are arranged in a linear grid (e.g., rows and columns) and dividers (e.g., 320, 330) are placed between the cells. Cells 310 may include a negative terminal and a positive terminal so that current produced from the cells may be directed to an external device or used to re-charge battery subpack 300. Although not shown, each battery subpack 300 may be connected (e.g., via wiring or other connections) to one or more electronic devices (e.g., another battery subpack) to provide power to electronic devices.

In the depicted implementation, first dividers 320 are positioned between each column of cells 310 and a second divider 330 is positioned between two adjacent rows of the cells. In some implementations, battery subpack 300 includes a plurality of second dividers 330 positioned between rows of cells 310 such as, for example, a second divider positioned between every row of cells. In some such implementations, a portion of cells 310 (e.g., interior portion) are surrounded by first and second dividers 320, 330. In some implementations, each divider (e.g., 320, 330) may be disposed in a plane that is different from the other dividers. Each cell 310 may be in contact with our spaced apart, such as within 0-3 cm, from of a divider (e.g., 320, 330) to facilitate removal of heat during operation of the batteries. For greater cell density, a distance between cells may be less than or equal to 1 cm. In some implementations, at least one cell (up to and including every cell) 310 may be completely surrounded by dividers 320, 330. For example, dividers 320, 330 may cooperate to define a chamber in which a cell may be disposed within. In some such implementations, a plurality of cells 310 may be coupled together and disposed within a chamber defined by dividers 320, 330. The chamber defined by the cooperating dividers may have the same cross-sectional shape as cells 310 (e.g., triangular, square, rectangular, hexagonal, octagonal, circular, elliptical, or otherwise polygonal or rounded) to enable battery subpack 300 to be densely packed

Each of cells 310 and dividers (e.g., 320, 330) may be coupled to a plate 340 that defines a base of battery subpack 300. In some implementations, plate 340, first dividers 320, and second dividers 330 are arranged orthogonal to one another. First dividers 320, second dividers 330 and/or plate 340 can be unitary or can be separate components that may be coupled together. As shown herein, plate 340 defines a plurality of channels 346 configured to transport fluid through the plate. Additionally, or alternatively, first and/or second dividers 320, 330 may define a one or more channels 336 configured to transport fluid through the dividers. As shown, channels 336 extend vertically, however, in other implementations, the channels defined by first and/or second dividers 320, 330 may extend horizontally along the dividers. For clarity, only a single channel 336 is shown, but other implementations, first and/or second dividers 320, 330 may define a plurality of channels (e.g., 336) for cooling battery subpack 300. Fluid may be transported through channels (e.g., 336, 346) constantly, intermittently, or not at all.

Battery subpack 300 may include a case 302 that defines a chamber 306. In some implementations, plate 340 cooperates with case 302 to define chamber 306. Each cell 310 and dividers (e.g., 320, 330) may be disposed within chamber 306 for some operation of the battery subpack. In some implementations, case 302 may be arranged in conjunction with first divider 320 and second dividers 330 to completely surround a portion of the plurality of cells 310. In some implementations, case 302 may include a thermally conductive material to facilitate heat removal from batter subpack 300.

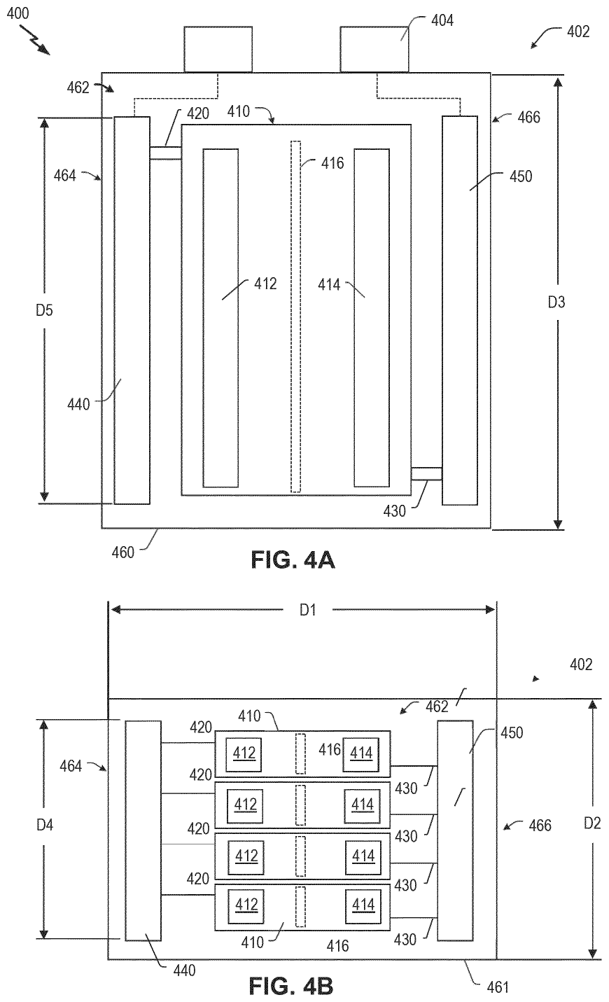

Referring to FIGS. 4A and 4B, illustrative views of a cell 402 that may be used in a battery subpack 400 is shown. For example, FIG. 4A shows a side view of cell 402 and FIG. 4B shows a top cross-sectional view of the cell. Battery subpack 400 and cell 402 may correspond to battery subpack 100, 200, 300 and cell 110, 112, 114, 210, 212, 214, 310, respectively.

Cell 402 may include a plurality of power units 410, a first busbar 440, and a second busbar 450. In some implementations, each power unit (e.g., 410) and/or busbars 440, 450 may be disposed within container 460 to allow for safe handling of cell 402. Cell 402 may include one more electrical connections 404 (e.g., terminals) configured to be connected (e.g. via wiring or other connections) to one or more electronic devices (not shown) to provide power to the electronic devices. As shown, electrical connections 404 include a pair of electrode terminals configured to provide electrical current to a device when the device is coupled to the terminals. In some implementations, referring to FIG. 4A, electrical connections 404 correspond with a negative terminal and a positive terminal Cell 402 may be a rechargeable, or secondary, cell that can be discharged and recharged multiple times. In an illustrative, non-limiting example, cell 402 may be a lead-acid battery, nickel-cadmium (NiCd) battery, nickel-metal hydride (NIMH) battery, lithium-ion (Li-ion) battery, lithium-ion polymer battery, and/or the like.

As shown, each power unit 410 includes a first active material 412, a second active material 414, and a separator 416 disposed between the first and second active materials. Separator 416 may be configured to prevent damage to the power units during charging or discharging operations. In the depicted implementations, each power unit 410 includes a first electrode that includes first connector 420 coupled to the first active material 412 and a second electrode that include second connector 430 coupled to the second active material 414. In some implementations, each power unit 410 may be aligned (e.g., in, a horizontal plane, as shown in FIG. 4B) with one other power units such that the power units form a stack. For example, each power unit 410 may be prismatic (e.g., include a rectangular cross-section) and disposed adjacent to one other power unit to enable multiple power units to be positioned within a small space (e.g., 462). As shown in FIG. 4B, cell 402 includes four power units 410 disposed in the stack; however, in other implementations, cell 402 may include less than four power units or more than four power units.

The first electrode (e.g., first active material 412 and first connector 420) and the second electrode (e.g., second active material 414 and second connector 430) may interact to cause an electrical and/or chemical reaction to generate power. As shown herein, the first electrode corresponds to a positive terminal and the second electrode corresponds to a negative terminal; however, in other implementations, the first electrode may correspond to the negative terminal and the second electrode corresponds to the positive terminal. In rechargeable power units, the first electrode may alternate between the cathode and the anode based on the state of cell 402. For example, the positive active material (e.g., 412) is the cathode in a discharge state and the anode in a charge state. First and second active materials 412, 414 may include any suitable material. In an illustrative, non-limiting example, first active material 412 may include a transition metal oxide (e.g., lithium cobalt oxide, lithium iron phosphate, lithium manganese oxide, and/or the like) and second active material 414 may include a carbon or silicon material (e.g., graphite, hard carbon, silicon carbon composite, and/or the like).

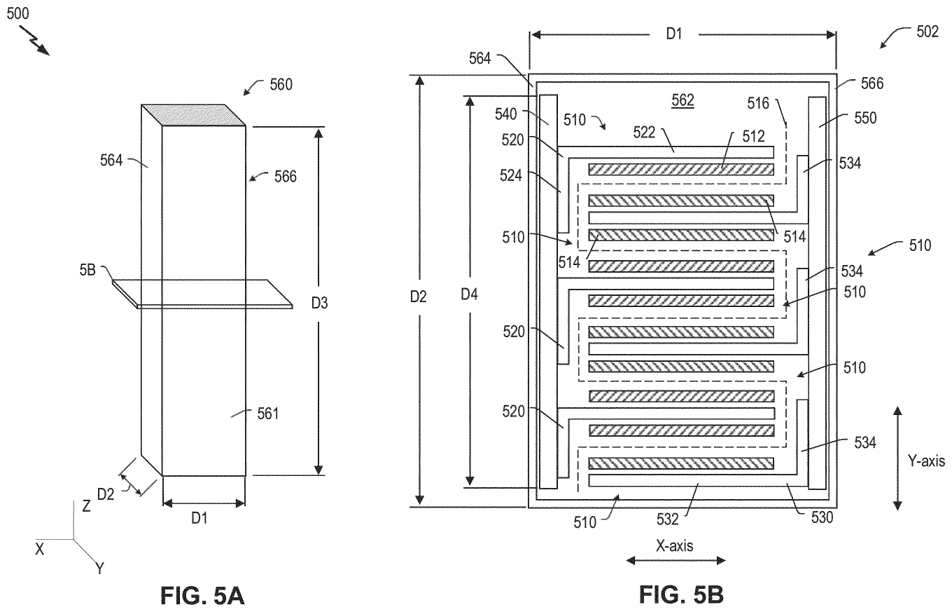

Separator 416 is positioned in between the first and second electrodes to prevent certain particles from travelling through the separator, between the first and second electrodes. In some implementations, separator 416 includes an electrolyte. For example, separator 416 may include a lithium salt in an organic solvent, a water-based electrolyte, a mixture of organic carbonates (e.g., ethylene carbonate or diethyl carbonate), aqueous electrolytes, composite electrolytes, solid ceramic electrolytes, and/or the like. In some implementations, separator 416 may include a single body that is disposed between the first and second electrodes of each power unit (as shown in FIG. 5B), while in other implementations, separator 416 may include several discrete separators (as shown in FIG. 4B) positioned between the first and second electrodes of the power units.

Connectors (e.g., 420, 430) are configured to transport electrical current from active materials 412, 414 to one or more other components of cell 402. For example, a first connector 420 (e.g., first current collector) may be coupled to first active material 412 of a power unit 410 and a second connector 430 (e.g., second current collector) may be coupled to second active material 414 of the power unit to distribute power produced from the power unit 410. In some implementations, each power unit 410 includes a first connector 420 and a second connector 430 coupled to the power unit to combine the output of the plurality of power units (e.g., 410) at a single source (e.g., one of the terminals) to achieve a higher energy output. To illustrate, first connectors 420 may couple each first active material 412 to first busbar 440 and second connectors 430 may couple each second active material 414 to second busbar 450 to provide a low resistance path for electrical current between power units (e.g., 410) and to decrease operational temperatures of cell 402 by removing heat through the first and second busbars. As shown in FIG. 4B, first connector 420 extends from first active material 412 to first busbar 440 to connect the first active material to the first busbar, and second connector 430 extends from second active material 414 to a second busbar 450 to connect the second active material to the second busbar. In other implementations, first connector 420 or second connector 430 may be coupled to one or, more other components of cell 402 (e.g., at electrical connections 404).

First busbar 440 and second busbar 450 are positioned adjacent to the plurality of power units 410. As shown in FIG. 4B, each busbar (e.g., 440, 450) is coupled to one or more of the plurality of power units (e.g., 410) to allow electric current to flow from the power units to the busbar. For example, first busbar 440 may be coupled to or in contact with first connector 420, which is coupled to or in contact with a portion (up to and including all) of power units 410 of the plurality of power units. Such configuration of first busbar 440 and first connector 420 enables the first busbar to remove heat and transport current from the power units. Additionally, or alternatively, second busbar 450 may be substantially parallel to first busbar 440 and coupled to one or more second connectors 430. Such configuration of the second busbar 450 and second connectors 430 may allow for more efficient removal of heat from the power units. As such, busbars (e.g., 440, 450) may include a suitable highly thermally conductive material such as aluminum, gold, copper, silver, tungsten, zinc, carbon (e.g., graphite), alloys thereof, and/or the like. In some implementations, a connector (e.g., 420) may include the same material as a busbar (e.g., 440) to ensure electrochemical compatibility. For example, first busbar 440 and first connectors 420 may include aluminum or an aluminum alloy and second busbar 450 and second connectors 430 may include copper or a copper alloy.

In some implementations, first busbar 440 may be positioned substantially perpendicular to first connector 420 and/or power unit (e.g., 410). First busbar 440 may include a body that spans at least a portion (e.g., at least 25%) of the stack of power units (e.g., 410) to provide increased thermal conductivity along a horizontal plane in cell 402. For example, first busbar 440 may span at least 25% of a thickness (e.g., D2) of cell 402. Additionally, or alternatively, first busbar 440 may span at least 25% of a length (e.g., D3) of cell 402. First busbar 440 may include a unitary body or two or more discrete segments that are coupled together and collectively span the portion of the stack. In this way and others, first busbar 440 may enable temperature regulation of cell 402 by causing an efficient removal of heat from hot spots, thereby keeping the power units of cell 402 at near uniform temperature. Such thermal regulation may enable cell 402 to include thick, high-capacity cells without (or with reduced) risk of temperature-related events. Second busbar 450 may be positioned similarly to first busbar 440. For example, second busbar 450 may be substantially parallel to first busbar 440 to remove heat along the same plane as first busbar 440. Although cell 402 is described as including two busbars (e.g., 440, 450); in other implementations, cell 402 may include a single busbar or more than two busbars.

Container 460 defines a cavity 462 and includes a first side 464 (e.g., first wall) and a second side 466 (e.g., second wall). First side 464 may be opposite the second side 466 such that the first and second sides cooperate to define at least a portion of cavity 462. As shown in FIG. 4B, container 460 has a width D1 measured between first side 464 and second side 466 along a straight line. Container 460 also has a thickness D2 that is orthogonal to width D1 and is measured between opposing sides of container 460 along a straight line. Container 460 has a length D3 that is measured between a top and bottom the container along a straight line. In the depicted implementations, width D1 and thickness D2 are measured in a horizontal plane and length D3 is measured in a vertical plane. Container 460 may include a rigid, semi-rigid, or flexible material and may be shaped in any suitable manner (e.g., cylindrical, prismatic, or the like) based on the desired application of cell 402. In the implementation shown in FIGS. 4A and 4B, container 460 corresponds to a rectangular prism, which may enable cell 402 to be utilized in applications where a small, high-powered battery is required.

Power units 410, busbars (e.g., 440, 450), and other components of cell 402 may be disposed within cavity 462. In this way, container 460 may provide an insulative protective casing around power units 410 and busbars (e.g., 440, 450) to prevent electrical accidents or damage that may arise from handling cell 402. As shown in FIGS. 4A and 4B, power units 410 disposed within cavity 462 may be stacked along an axis that is parallel to thickness D2 of container 460. Busbars (e.g., 440, 450) may be disposed between the stack of power units (e.g., 410) and the sides (e.g., 464, 466) of container 460. For example, first busbar 440 may be interposed between first side 464 and the stack of power units 410. Additionally, or alternatively, second busbar 450 may be interposed between second side 466 and the stack of power units 410.

Each of first and second busbar 440, 450 may be completely disposed within container 460. In some implementation, first busbar 440 may be coupled to, or disposed adjacent to, first side 464. In some such implementations, first busbar 440 spans at least 25% of thickness D2 of container 460. For example, a width D4 of first busbar 440 may be greater than, equal to 25 percent of thickness D2 at first side 464. Additionally, or alternatively, a length D5 of first busbar 440 spans at least 25% of length D3 of container 460, the length D5 being measured perpendicular to width D4 of the first busbar. For example, length D5 of first busbar 440 may be greater than or equal to 25 percent of length D3 of container 460. In some implementations, first busbar 440 spans at least a majority of each of thickness D2 and length D3 of container 460 at first side 464. Second busbar 450 may be coupled to, or disposed adjacent to, second side 466 and span at least 25% (e.g., between 25% and 100%) of thickness D2 and/or length D3 of container 460 at the second side 466. While not depicted herein, cell 402 may include a third and/or a fourth busbar disposed between a third side and a fourth side, respectively, of container 460.

In some implementations, the plurality of power units 410, first busbar 440, and second busbar 450 are disposed within cavity 462. For example, first busbar 440 is interposed between first current collector (e.g., 420) and first side 464 of container 460. In some implementations, second busbar 450 is interposed between second current collector (e.g., 430) and second side 466 of container 460. In some implementations, first busbar 440 is in contact with each first electrode (e.g., 412, 420) of the plurality of power units 410. At least one of the first electrodes (e.g., 412, 420) includes a first current collector (e.g., 420) and an active material (e.g., 412). In some implementations, second electrodes (e.g., 414, 430) may include a second current collector (e.g., 430) coupled to second busbar 450. First current collector (e.g., 420) and first busbar 440 may each include a first material and second current collector (e.g., 430) and second busbar 450 may each include a second material. The first and second material may be the same or a different material. In some implementations, first busbar 440 spans an area that is greater than or equal to 25% of first wall (e.g., 464). Additionally, or alternatively, second busbar 450 spans an area that is greater than or equal to 25% of the second wall (e.g., 466).

In the foregoing implementations, first busbar 440 may operate to efficiently remove heat from power units 410 and maintain substantially uniform temperatures across each power unit. For example, first busbar 440 may be coupled to first electrode (e.g., first active material and first connector) to remove heat away from each power unit 410 along a first plane that is parallel to the length D3 of container 460 and along a second plane that is parallel to the thickness D2 of the container. In this way and others, heat can be distributed from the power units to reduce operational temperatures of cell 402. Additionally, first busbar 440 may be positioned adjacent to first side 464 (e.g., first wall) to distribute heat toward the exterior of container 460. Such implementations may enable more efficient heat transfer from power units 410 due to the surface area of first busbar 440, easier access for external cooling components to the heat sink (e.g., first busbar), and other manners described herein. In this way, first busbar 440 and second busbar 450 may interact with dividers (e.g., 120, 220, 230, 320, 330) to remove heat from cells 402. In some implementations, first busbar 440 and/or second busbar 450 may be within 50-500 microns, such as 100-300 microns, of a divider (e.g., 120, 220, 230, 320, 330) to facilitate removal of heat during operation of the cells.

Referring to FIGS. 5A-5B, shown is an example of a cell 502 of a battery subpack 500. To illustrate, FIG. 5A shows a perspective view of cell 502 and FIG. 5B shows a top, cross-sectional view of the cell 502 taken along plane 5B. Battery subpack 500 and cell 502 may correspond to battery subpack 100, 200, 300, 400 and cell 110, 112, 114, 210, 212, 214, 310, 402, respectively. For example, cell 502 includes a plurality of power units 510, a first busbar 540, and a second busbar 550 disposed within a container 560. The power units 510, first busbar 540, second busbar 550, and container 560 may include or correspond to power units 410, first busbar 440, second busbar 450, and container 460, respectively.

As shown in FIG. 5A, container 560 includes one or more walls 561, a first side 564, and a second side 566 that is opposite to the first side. Walls 561 cooperate to define a cavity 562 in which components of cell 502 may be stored. In, some implementations, first side 564 and second side 566 correspond to a first wall and second wall, respectively, of the one or more walls 561. In the depicted implementations, container 560 is prismatic (e.g., cuboid) and includes four walls (e.g., 561), yet, in other implementation, container 560 may be sized and shaped based on an application of cell 502. For example, a cross-section of container 560 may be rectangular (as shown in the implementation of FIG. 5B) triangular, or otherwise polygonal (whether having sharp and/or rounded corners), circular, elliptical, or otherwise rounded, or can have an irregular shape.

By way of illustration, cell 502 may be described with reference to a right handed coordinate system, as shown in FIG. 5A, in which the x-axis corresponds to a left-right direction of the page, the Z-axis corresponds to an up-down direction on the page, and the Y-axis corresponds to an axis that travels orthogonally into the page. Container 560 has a width D1, a thickness D2, and a length D3, each of which may be measured along a straight line from opposing sides (e.g., walls) of container 560. As shown in FIG. 5A, width D1 is measured along the x-axis, thickness D2 is measured along the y-axis, and length D3 is measured along the z-axis. In the depicted implementation, thickness D2 may be greater than (e.g., 10% greater than) width D1, however, in other implementations, width D1 may be substantially equal to thickness D2, and, in yet other implementations, width D1 may be greater than thickness D2.

FIG. 5B shows a top sectional view of cell 502 taken about plane 5B in which the right handed coordinate system is rotated such that the x-axis corresponds to a left-right direction of the page and the y-axis corresponds to an up-down direction on, the page. As shown, the Z-axis is not illustrated as it extends into and out of the page. Each power unit (e.g., 510) includes a first active material 512, a second active material 514, a separator 516, a first connector 520 (e.g., first current collector), and a second connector 530 (e.g., second current collector). First active material 512, second active material 514, and at least a portion of separator 516 are disposed between first connector 520 and second connector 530 of each power unit, the separator interposed between the first and second active materials 512, 514 to selectively permit particles travelling between the first and second active materials. First active material 512 is coupled to first connector 520 and a second active material 514 is coupled to the second connector 530 to create an electrical current that flows through cell 502 from one connector to the other. To illustrate, first active material 512 and second active material 514 may include materials that allow electrons to flow between the materials (e.g., transition metal oxide and carbon, as a non-limiting example). In some implementations, power units 510 may share components to decrease the volume of the power unit and allow cell 502 to be more compact. For example, a single first connector (e.g., 520) may be utilized as the first connector for two adjacent power units. In such implementations, the first connector (e.g., 520) is interposed between two layers of first active material (e.g., 512). Additionally, or alternatively, separator 516 may include a unitary body that that extends through each power unit 510 such that a portion of the separator is disposed between first active material 512 and second active material 514 of each power unit.

First connector 520 may include a body 522 (e.g., first portion) and a tab 524 (e.g., second portion). Body 522 is coupled to (e.g., in contact with) first active material 512 to collect an electrical charge as power unit 510 charges and discharges. To illustrate, body 522 may extend in a direction parallel to first active material 512 and, in some implementations, the body may span (or cover) approximately an entirety of first active material 512 (e.g., a surface area of the body is greater than a surface area of the first active material). As shown, at least a portion of body 522 extends past one end of active material (e.g., 512, 514). In this way and others, first connectors 520 may transfer heat away from power unit 510 to maintain normal operational temperatures during use of cell 502.

Tab 524 extends away from body 522. To illustrate, tab 524 may be angularly disposed relative to (e.g., perpendicular to) body 522 to direct current collected at body 522 to one or more other components of cell 502. For example, tab 524 of each first connector 520 may be in contact with first busbar 540 to deliver electrical current generated from each power unit 510 to the first busbar. In this manner, first busbar 540 may distribute heat from tab 524 via conduction. For example, connecting tabs 524 to first busbar 540 enables heat generated by power units 510 to be distributed by conduction from first connector 520 to the first busbar. Such positioning and coupling of tab 524 and first busbar 540 may enable heat to be more readily transferred along the X-axis (along body 522) and the Y-axis (along tab 524 and first busbar 540) as compared to traditional batteries. In this manner and others, heat produced at each power unit 510 may be more uniformly distributed and can minimize hot spots that can occur within the cell. In some implementations, tab 524 may extend in a direction parallel to first busbar 540 (e.g., parallel to a width D4 of first busbar 540) to achieve a larger contact surface with the first busbar. In an illustrative, non-limiting example, tabs 524 may collectively span, a distance of first busbar 540 that is greater than or equal to 25% of width D4 of the first busbar.

Second connector 530 may include one or more features similar to first connector 520. For example, second connector 530 includes a body 532 (e.g., first portion) and a tab 534 (e.g., second portion) that extends away from body 532. As shown in FIG. 5B, body 532 is in contact with second active material 514 and tab 534 is in contact with second busbar 550 to distribute current generated by power unit 510 to the second busbar. In some implementations, body 532 and tab 534 may be substantially parallel to active material 514 and second busbar 550, respectively. In an illustrative, non-limiting example, tabs 534 may collectively span a distance of second busbar 550 that is greater than or equal to 25% of a width (e.g., D4) of the second busbar. Additionally, or alternatively, body 532 of second connector 530 may be substantially parallel to body 522 of first connector 520. Likewise, tab 534 of second connector 530 may be substantially parallel to tab 524 of first connector 520. In this way and others, second connectors 530 may transfer heat away from power unit 510 to second busbar 550 via conduction to increase heat transfer in the X-axis (along body 532) and the Y-axis (along tab 534 and second busbar 550) to maintain normal operational temperatures during use of cell 502. In some implementations, tab 534 and/or 524 may be parallel to a divider (e.g., 120, 220, 230, 320, 330) to increase the surface area of heat transfer between the tabs, the busbars, and/or the dividers. In some implementations, tab 534 and/or 524 may be within 50-500 microns, such as 100-300 microns, of a divider (e.g., 120, 220, 230, 320, 330) to facilitate removal of heat during operation of the cells.

First connector 520 (e.g., body 522 and tab 524) and/or second connector 530 (e.g., body 532 and tab 534) may include a thermally conductive material, such as aluminum, gold copper, silver, tungsten, zinc, carbon (e.g., graphite), alloys thereof, and/or the like, to conduct electrical current and transfer heat away from power units 510. As shown in FIG. 5B, first connector 520 and second connector 530 may be unitary members. In some other implementations, first connector 520, second connector 530, or both, may include one or more discrete components coupled together.

First busbar 540 and a second busbar 550 are disposed on opposing sides of container 560. First busbar 540 is positioned adjacent to first side 564. For example, first busbar 540 may be in contact with first side 564 or, in other implementations, one or more gaps may be formed between the first busbar and first side 564. Additionally, or alternatively, second busbar 550 is positioned adjacent to second side 566. For example, second busbar 550 may be in contact with second side 566 or, in other implementations, one or more gaps may be formed between the second busbar and the second side 566. In some implementations, first busbar 540 may be positioned parallel to second busbar 550.

First busbar 540 has a width D4 that is measured from opposing sides of the first busbar along a straight line. In some implementations, first busbar 540 extends in a direction that is substantially parallel to first side 564. To illustrate, width D4 of first busbar 540 may be aligned parallel to a length of first side 564. As shown in FIG. 5B, a width of first side 564 corresponds to thickness D2 of container 560. In some implementations, a width D4 of first busbar 540 spans at least 25% of first side 564. For example, width. D4 of first busbar 540 may be greater than or equal to 25 percent of the width of first side 564 of container 560 (e.g., thickness D2). Additionally, or alternatively, a-length (e.g., D5) of first busbar 540 may be greater than or equal to 25 percent of the length (e.g., D3) of first side 564 of container 560. In this way and others, first busbar 540 may increase heat transfer of cell 502 along the Z-axis and the Y-axis.

First busbar 540 includes a thermally conductive material. For example, first busbar 540 may include aluminum, gold, copper, silver, tungsten, zinc, carbon (e.g., graphite), alloys thereof, and/or the like. In some implementations, first busbar 540 and first connector 520 include the same material (e.g., copper) to ensure electrochemical compatibility between the two components. For brevity, a discussion of second busbar 550 is omitted; however, it is noted that second busbar 550 and second connectors 530 may function similarly to, and include one or more structural similarities as, first busbar 540 and first connectors 520.

In the foregoing implementations, first busbar 540 and first connector 520 may operate in conjunction to efficiently remove heat from power units 510 and maintain uniform temperatures across each power unit. For example, first connector 520 may remove heat away from power units 510 along body 522 (in the X-axis) and tab 524 (in the Y-axis) and first busbar 540 may further remove heat (in the Y-axis). Additionally, each of first connector 520 and first busbar 540 span a portion of length D3 of container 560 to distribute heat along the Z-axis. In this way and others, first busbar 540 and/or first connector 520 may distribute heat along each plane of cell 502 to decrease operational temperatures. As a result of this thermal regulation, cell 502 may include more power units (e.g., 510) while still maintaining operational temperatures of the cell.

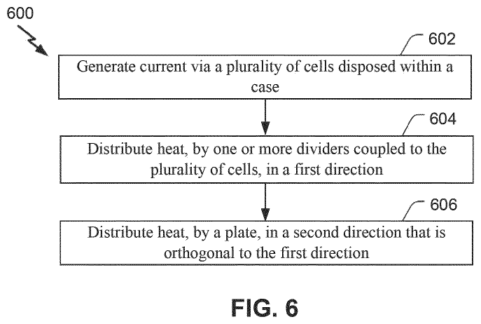

Referring to FIG. 6, an example of a method of operating a battery subpack is shown. Method 600 may be performed by battery subpack 100, 200, 300, 400, and/or 500, including cells 110, 112, 114, 210, 212, 214, 310, 402, and 502, as non-limiting examples.

Method 600 includes generating current, by a plurality of cells disposed within a case, at 602. The plurality of cells and the case may include or correspond to cells 110, 110, 112, 114, 210, 212, 214, 310, 402, and 502, and case 102, 302 respectively. In some implementations, method 600 may further includes charging or discharging the plurality of cells. For example, operating the battery subpack may include transferring power from the plurality of cells to an electrical device.

Method 600 includes distributing heat, by one or more dividers, in a first direction, at 604. The one or more dividers may include or correspond to dividers 120, 220, 230, 320, 330. In some implementations, distributing heat in the first direction is performed by the one or more dividers configured to surround at least a portion of the cells. For example, one or more dividers may transfer heat from the cells in a direction that is parallel to a height of the cells and in a direction that is orthogonal to the height of the cells. In some implementations, at least some of the dividers are orthogonal to each other to facilitate removal of heat along two orthogonal planes. In some implementations, a plurality of fibers of the one or more dividers are oriented such that heat distributing from the first end of the fiber to the second end of the fiber is also distributing in the first direction. Additionally, method 600 may include distributing heat by a plurality of dividers configured to completely surround the plurality of cells. Further, method 600 may include distributing heat by a divider defining a channel. In some implementations, the channel may include a liquid.

Method 600 further includes distributing heat, by a plate, in a second direction that is orthogonal to the first direction, at 606. The plate may include or correspond to plate 140, 240, 340. In some implementations, distributing heat in the second direction is performed by the plate. For example, the plate may be coupled to the one or more dividers such that the plate and one or more dividers are orthogonal and the plate may transfer heat from the one or more dividers in the second direction. Method 600 may include distributing heat by a plate defining a channel. In some implementations, the plate may include a liquid.

Thus, the configuration of battery subpack enables heat in one or more cells to be distributed by one or more dividers and a plate. In this way and others, one or more dividers and a plate may regulate the temperature among the cells and decrease an overall operational temperature of battery subpack.

### EXAMPLES

The present disclosure will be described in greater detail by way of specific examples. The following examples are offered for illustrative purposes only and are not intended to limit the disclosure in any manner Those of skill in the art will readily recognize a variety of noncritical parameters that can be changed or modified to yield essentially the same results.

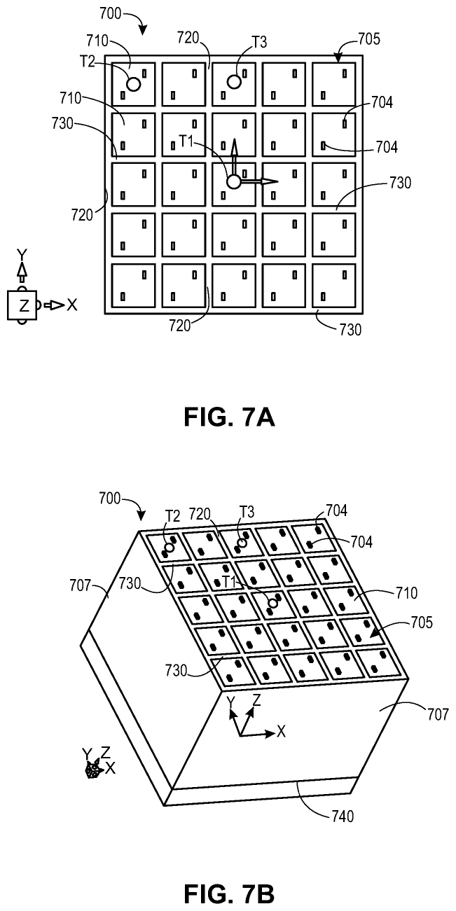

Referring to FIGS. 7A and 7B, a battery subpack 700 having a plurality of cells 710 arranged in a 5×5 grid, with first dividers 720 and second dividers 730 interposed between each cell is shown. The dividers 720, 730 are coupled to a plate 740 and each cell included tabs 704. An Experimental Analysis (e.g., thermal profile analysis) was performed during operation of battery subpack 700 at various discharge rates to determine the temperature profile and thermal management of the battery. The analysis was modeled using Ansys Fluent V 19.1.

For the following examples, battery subpack 700 was sized as a cuboid having a length of 90 mm, a width of 90 mm, and -a height of 60 mm. The cells 710 and plate 740 were sized accordingly, each cell having a length of 15 mm, a width of 15 mm, and a height of 60 mm and plate 740 having a length of 90 mm, a width of 90 mm, and a height of 2.5 mm. In the depicted examples, the material properties of battery subpack 700 is shown in Table 1, below:

TABLE 1
THERMO-PHYSICAL PROPERTIES OF BATTERY SUBPACK

| | | | Specific | Thermal | |
|---|---|---|---|---|---|
| | | Density, | heat | conductivity | Surface |
| Component | Material | kg/m³ | (J/kgK) | (W/mK) | emissivity |
| Cells | Averaged | 2780 | 1280 | In-plane: 30 | NA |
| | properties* | | | Through- | |
| | | | | plane: 3 | |
| Tab | Copper | 8970 | 381 | 388 | 0.1 |
| Cellular | Conductive | 1560 | 1250 | 50 | 0.92 |
| Structure | thermo- | | | | |
| | plastic | | | | |

For cells 310, orthotropic thermal conductivity was modeled for both in-plane thermal conductivity—along the planar surface (x & y-directions of FIG. 7B)—and through-plane thermal conductivity—along the thickness (z-direction of FIG. 7B). The thermal analysis was modeled at ambient conditions of 25° C. at 1 atm pressure. Further, the heat transfer coefficient (HTC) of a top surface 705 was set to 8 W/m²K to mimic natural convection conditions, the HTC of external side surfaces 707 was set to 75 W/m²K to mimic forced convection conditions, and the HTC of plate 740 was set to 75 W/m²K to mimic heat removal through the cooling plate. The maximum temperature for battery pack was recorded, and the temperatures were monitored at three separate cell locations (T1, T2, T3) during operation of the battery. The first cell location T1 is located at the center cell of the battery subpack 700 (e.g., at the intersection of the X and Y axis), the second cell location T2 is located at a corner cell (e.g., 710) and is displaced from location T1 equally along the X and Y axis, and the third cell location T3 is located at a middle exterior cell that lies on the Y-axis and is displaced from the X-axis.

### Example 1

### Thermal Analysis of Cells at 1-C Discharge

Thermal analysis, as described above, was performed with a discharge rate of 1-C for 60 minutes (complete discharge). The simulation was modeled as a transient state with 1-C rates for a typical 3 ampere-hour (Ah) cell. Typical heat generated in cells will be at the rate of 0.5 W/Ah for 1-C rates, thus, the heat generation per cell (e.g., 710) was set at 1.5 watts (W).

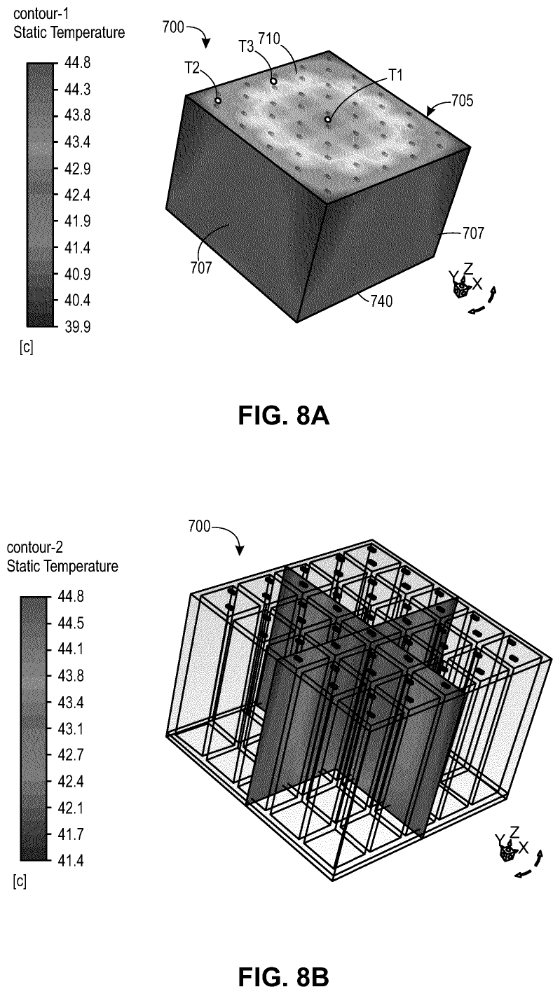

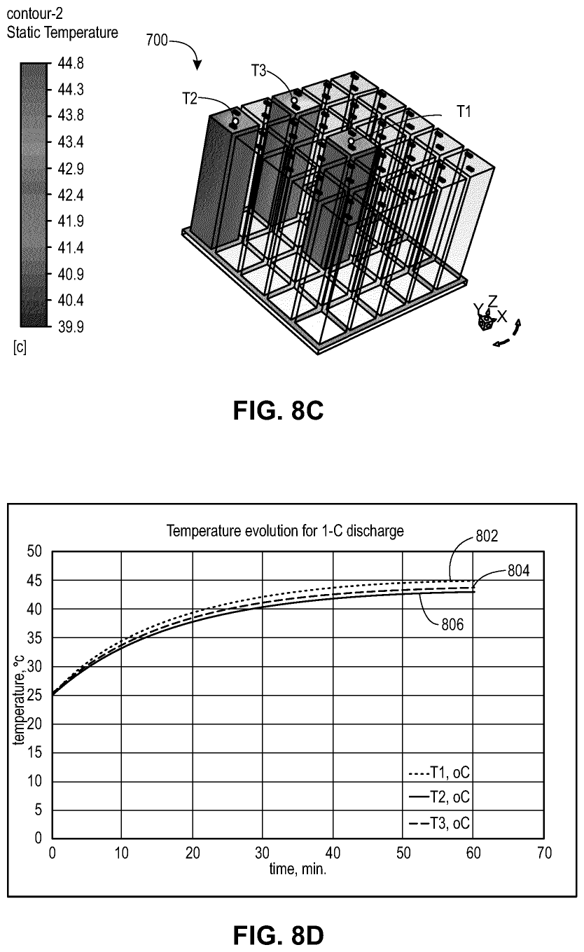

Referring to FIGS. 8A-8D, illustrative models of the thermal analysis showing a temperature profile of battery subpack 700 during operation at a discharge rate of 1-C is shown. For example, FIG. 8A depicts a temperature profile of an exterior (e.g., 705, 707) of battery subpack 700, FIG. 8B depicts a temperature profile of the battery subpack along planes in the X and Y axis, FIG. 8C depicts a temperature profile of each individual cell 710 at the three temperature locations (T1, T2, T3), and FIG. 8D depicts a graph showing the maximum temperatures at the three temperature locations (T1, T2, T3) with respect to time.

As shown, the heat generated from cells 710 was distributed away from the center toward the exterior of battery subpack 710. The maximum cell temperature of the battery subpack 700 occurred at the central cell (e.g., T1) and was 44.8° C. and the minimum temperature occurred at the corner cell (T2) and was 41.0° C. Thus, the maximum temperature differential of battery subpack 700 was 3.8° C. which corresponds to a relatively uniform, temperature differential. Further, the maximum temperature difference between adjacent cells was found to be 2.5° C.

A minimum temperature, a maximum temperature, and an average temperature were taken at the expiration of 60 minutes for each cell at the three temperature locations (T1, T2, T3). The results of which are shown in Table 2, below:

TABLE 2
TEMPERATURE DIFFERENTIAL OF BATTERY
SUBPACK AT 1-C DISCHARGE

| Location | Minimum (° C.) | Maximum (° C.) | Average (° C.) |
|---|---|---|---|
| T1 | 43.7 | 44.8 | 44.4 |
| T2 | 40.0 | 42.9 | 41.9 |
| T3 | 41.5 | 43.7 | 43.0 |

As shown, the temperature differential at each individual cell is also relatively uniform. Shown in FIG. 8C, the maximum temperature differential of an individual cell occurred at the corner cell (T2) and was 2.9° C. However, each of the cells along the X and Y plane, shown in FIG. 8B, had a maximum temperature differential along a vertical axis that is less than 1.0° C. The temperature of battery subpack 700 increases as the battery is discharged. As depicted in FIG. 8D, the maximum temperatures for each cell at the three temperature locations (T1, T2, T3) increases by less than 1.0° C. during the last 10 minutes of operation. To illustrate, curves 802, 804, and 806 correspond to the maximum temperatures at T1, T2, and T3, respectively, during discharge of battery subpack 700. Thus, operating battery subpack 700 at a similar wattage for extended periods would not likely increase the temperatures of the cells. Accordingly, battery subpack is kept below 45° C. during operation. Thus, the arrangement of cells 710, dividers, 720, 730, and plate 740 facilitated high in-plane conductivity of the cuboid battery subpack to facilitate high heat removal from the a battery with even temperature distribution between the cells.

### Example 2

### Thermal Analysis of Cells at 2-C Discharge

Thermal analysis, as described above, was performed with a discharge rate of 2-C for 30 minutes (complete discharge). The simulation was modeled as a transient state with 2-C rates for a typical 3 ampere-hour (Ah) cell. Typical heat generated in cells will be at the rate of 1.0 W/Ah for 2-C rates, thus, the heat generation per cell (e.g., 710) was set at 3.0 W.

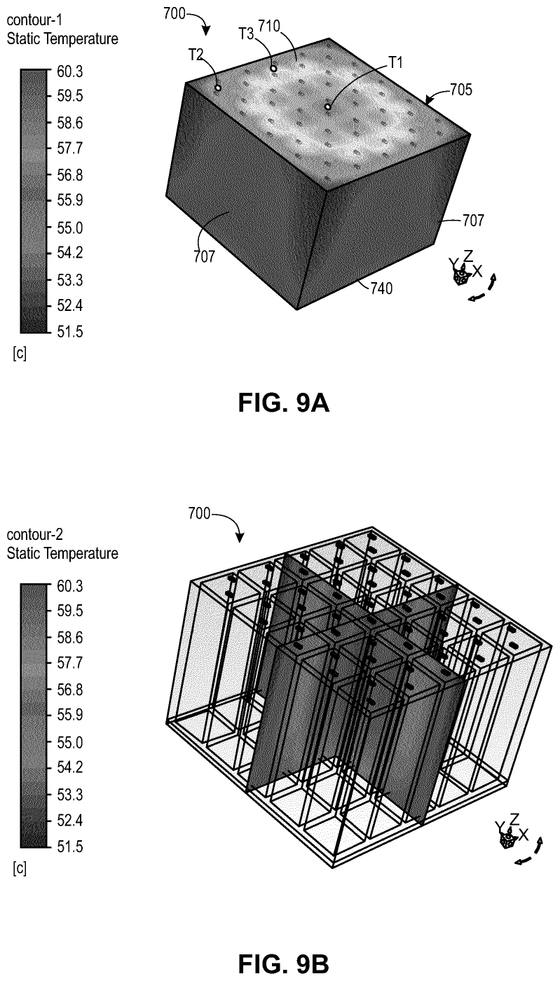

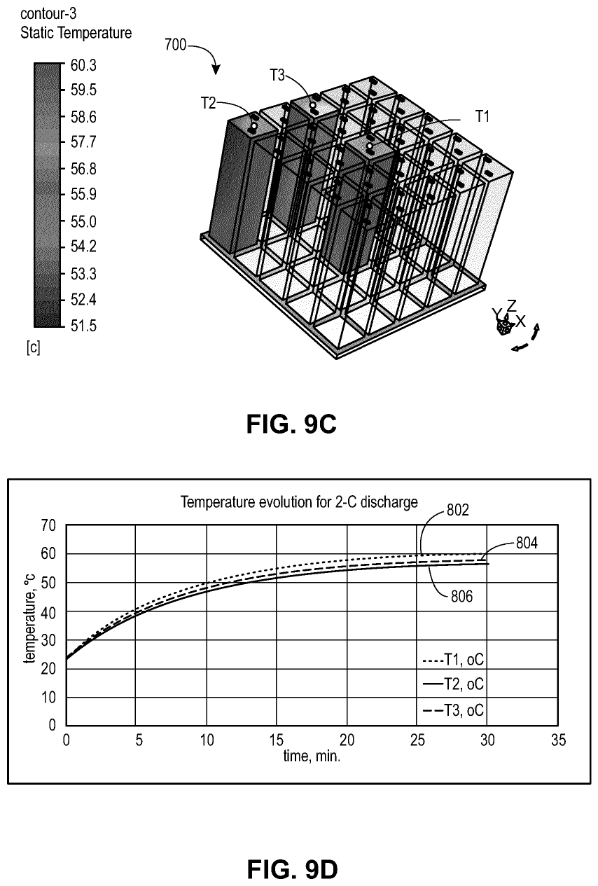

Referring to FIGS. 9A-9D, illustrative models of the thermal analysis showing a temperature profile of battery subpack 700 during operation at a discharge rate of 2-C is shown. For example, FIG. 9A depicts a temperature profile of an exterior (e.g., 705, 707) of battery subpack 700, FIG. 9B depicts a temperature profile of the battery subpack along planes in the X and Y axis, FIG. 9C depicts a temperature profile of each individual cell 710 at the three temperature locations (T1, T2, T3), and FIG. 9D depicts a graph showing the maximum temperatures at the three temperature locations (T1, T2, T3) with respect to time.

As shown, the heat generated from cells 710 was distributed away from the center toward the exterior of battery subpack 710. The maximum cell temperature of the battery subpack 700 occurred at the central cell (e.g., T1) and was 60.3° C. and the minimum temperature occurred at the corner cell (T2) and was 51.7° C. Thus, the maximum temperature differential of battery subpack 700 was 8.6° C. While this is higher than the differential during discharge at 1-C, this is still within normal operational temperatures. Additionally, the maximum temperature difference between adjacent cells was found to be 4.4° C. As such, it appears temperature is still distributed relatively evenly when the discharge rate is increased.

A minimum temperature, a maximum temperature, and an average temperature were taken at the expiration of 30 minutes for each cell at the three temperature locations (T1, T2, T3). The results of which are shown in Table 3, below:

TABLE 3
TEMPERATURE DIFFERENTIAL OF BATTERY
SUBPACK AT 2-C DISCHARGE

| Location | Minimum (° C.) | Maximum (° C.) | Average (° C.) |
|---|---|---|---|
| T1 | 58.3 | 60.3 | 59.5 |
| T2 | 51.7 | 56.8 | 55.1 |
| T3 | 54.4 | 58.3 | 57.1 |

As shown, the temperature differential at each individual cell is also relatively uniform at the high discharge rate. Shown in FIG. 9C, the maximum temperature differential of an individual cell occurred at the corner cell (T2) and was 5.1° C. However, each of the cells along the X and Y plane, shown in FIG. 8B, had a maximum temperature differential along a vertical axis that is less than 3.0° C.

The temperature of battery subpack 700 increases with lower slope towards the end of the discharge. As depicted in FIG. 9D, the maximum temperatures for each cell at the three temperature locations (T1, T2, T3) increases by less than 2.5° C. during the last 10 minutes of operation. To illustrate, curves 902, 904, and 906 correspond to the maximum temperatures at T1, T2, and T3, respectively, during discharge of battery subpack 700. Thus, operating battery subpack 700 at these high discharge rates for extended periods of time is within the safety bounds of the cells. Accordingly, battery subpack is kept around 60° C. during operation. While this is on the higher end of typical discharge temperatures for Li-ion batteries, this is still within the acceptable ranges and poses no major risk, of thermal runaway. Thus, the arrangement of cells 710, dividers, 720, 730, and plate 740 facilitated high in-plane conductivity of the cuboid battery subpack to facilitate high heat removal from the a battery with even temperature distribution between the cells. This battery pack can be further optimized by increasing the thermal conductivities of the dividers or z-axis thermal conductivity of the cells or the heat transfer coefficient of the cooling plate and providing a great deal of control over the thermal management of battery pack in charge or discharge.

Although aspects of the present application and their advantages have been described in detail, it should be understood that various changes, substitutions and alterations can be made herein without departing from the spirit and scope of the disclosure as defined by the appended claims. Moreover, the scope of the present application is not intended to be limited to the particular implementations of the process, machine, manufacture, composition of matter, means, methods and steps described in the specification. As one of ordinary skill in the art will readily appreciate from the above disclosure, processes, machines, manufacture, compositions of matter, means, methods, or steps, presently existing or later to be developed that perform substantially the same function or achieve substantially the same result as the corresponding implementations described herein may be utilized. Accordingly, the appended claims are intended to include within their scope such processes, machines, manufacture, compositions of matter, means, methods, or steps.

The above specification provides a complete description of the structure and use of illustrative configurations. Although certain configurations have been described above with a certain degree of particularity, or with reference to one or more individual configurations, those skilled in the art could make numerous alterations to the disclosed configurations without departing from the scope of this disclosure. As such, the various illustrative configurations of the methods and systems are not intended to be limited to the particular forms disclosed. Rather, they include all modifications and alternatives falling within the scope of the claims, and configurations other than the one shown may include some or all of the features of the depicted configurations. For example, elements may be omitted or combined as a unitary structure, connections may be substituted, or both. Further, where appropriate, aspects of any of the examples described above may be combined with aspects of any of the other examples described to form further examples having comparable or different properties and/or functions, and addressing the same or different problems. Similarly, it will be understood that the benefits and advantages described above may relate to one configuration or may relate to several configurations. Accordingly, no single implementation described herein should be construed as limiting and implementations of the disclosure may be suitably combined without departing from the teachings of the disclosure.

The previous description of the disclosed implementations is provided to enable a person skilled in the art to make or use the disclosed implementations. Various modifications to these implementations will be readily apparent to those skilled in the art, and the principles defined herein may be applied to other implementations without departing from the scope of the disclosure. Thus, the present disclosure is not intended to be limited to the implementations shown herein but is to be accorded the widest scope possible consistent with the principles and novel features as defined by the following claims. The claims are not intended to include, and should not be interpreted to include, means-plus- or step-plus-function limitations, unless such a limitation is explicitly recited in a given claim using the phrase(s) “means for” or “step for,” respectively.

### COMPARATIVE EXAMPLE

### Materials and Methods—Battery Data

An extensive assessment of electric vehicle battery systems on the market was considered for comparison purpose. For this, available data for as many electric vehicle battery systems as available from OEMs was aggregated from a journal article of title “From Cell to Battery System in BEVs: Analysis of System Packing Efficiency and Cell Types” published in “World Electric Vehicle Journal”. Due to the fact that data on vehicles is not easy to find, it has to be noted that the aggregation of the data was a combinatorial effort. Some sources give information on cell and module sizes of a vehicle, others for example only on the system design. This data was then assembled into a full battery system data set of the respective electric vehicle.

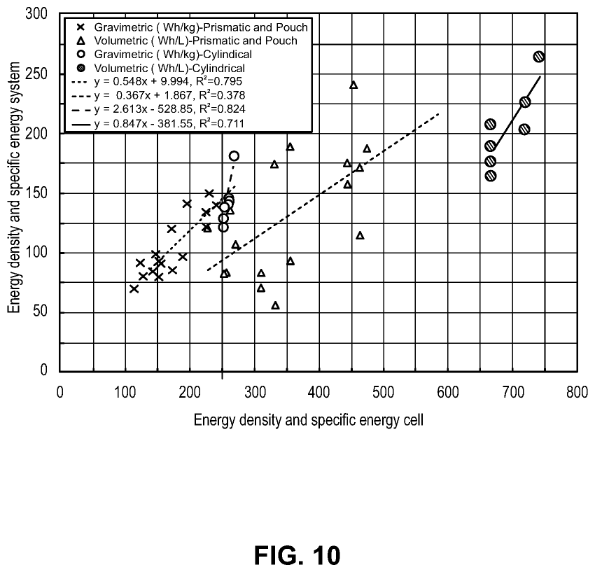

Referring to FIG. 10, the efficiency of the specific energy of all cell types, is higher than their energy density. It can also be noted that the gravimetric correlation is very high (R²=0.795 for pouch and prismatic cells; R²=0.824 for cylindrical cells), the volumetric correlation of prismatic and pouch cell vehicles (R²=0.378) however is rather weak. It depicts 40 to 45% of loss in specific energy and 65 to 70% of loss in energy density at the system level as compared to the cell level.

The efficiency rates are shown in Table 4 to see where these efficiency gets lost, the two combinations cell to module, and module to system, need to be analyzed.

TABLE 4
EFFICIENCY RATE OF CELL LEVEL TO SYSTEM LEVEL

| | Gravimetric | | Volumetric | |
|---|---|---|---|---|
| Battery | Prismatic | Gravimetric | Prismatic | Volumetric |
| Characteristics | and Pouch | Cylindrical | and Pouch | Cylindrical |
| Average | 0.58 | 0.55 | 0.35 | 0.3 |
| Lowest | 0.5 | 0.48 | 0.17 | 0.25 |
| Highest | 0.74 | 0.67 | 0.53 | 0.36 |

From the data, it is clear that the system level energy density varies from 17% to 53% of the system level with the average around 30 to 35%. So on an average, the loss in energy density for all types of cells is between 65 to 70%.

### Example 3

### Novel Multifunctional Cell High Energy Dense Module/Pack

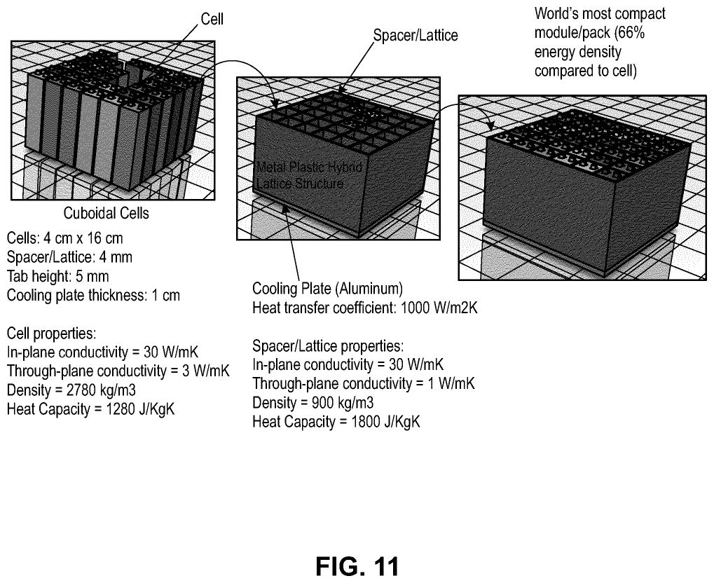

In the present invention, the cells and the module/pack are redesigned with the following considerations:
Following nature's lead to optimize materials, form, and function—cell, module, and pack are reimagined
Highest packing efficiency and energy density—100% more than conventional cell Amenable to cell-to-pack and cell-to-skateboard
   Optimal than 4680 cylindrical or CATL prismatic cells
Very low risk as this solution fits into existing pouch cell manufacturing with minimal modifications of an existing line
No need for new chemistry
Potentially lowest cell internal resistance among all formats
Homogeneous temperature and electrical fields
   Increased cycle life
Safe discharge of cells upon abuse conditions
   Overcharge and dendrite formation
   Crash
Designed for easy disassembly and recycling
   Square cross-section cells are considered as effective (FIG. 11) with each cell of 4 cm×4 cm×16 cm at 128 Wh/35 Ah (500 Wh/L). The cells have in-plane conductivity of 30 W/mK, through-plane conductivity of 3 W/mK, Density of 2780 kg/m³ and specific heat of 1280 J/KgK. A spacer present in the inventive battery pack is 4 mm thick with in-plane conductivity of 30 W/mK, through-plane conductivity of 1 W/mK, Density of 900 kg/m³ and specific heat of 1800 J/KgK. The bottom cooling plate is representative of aluminum of thickness 1 cm with cooling channels embedded that can achieve a heat transfer coefficient of 1000 W/m²K. The inventive 100 kWh battery pack has 28×28 cells=780 cells, 1.23 m×1.23 m, total height=20 cm, and volumetric=330 Wh/L.
   The loss in energy density obtained based on the inventive battery pack is only 34% as compared to 65-70% on reference battery packs on the electric vehicles on the market. This corresponds to almost 100% increase in the energy density.

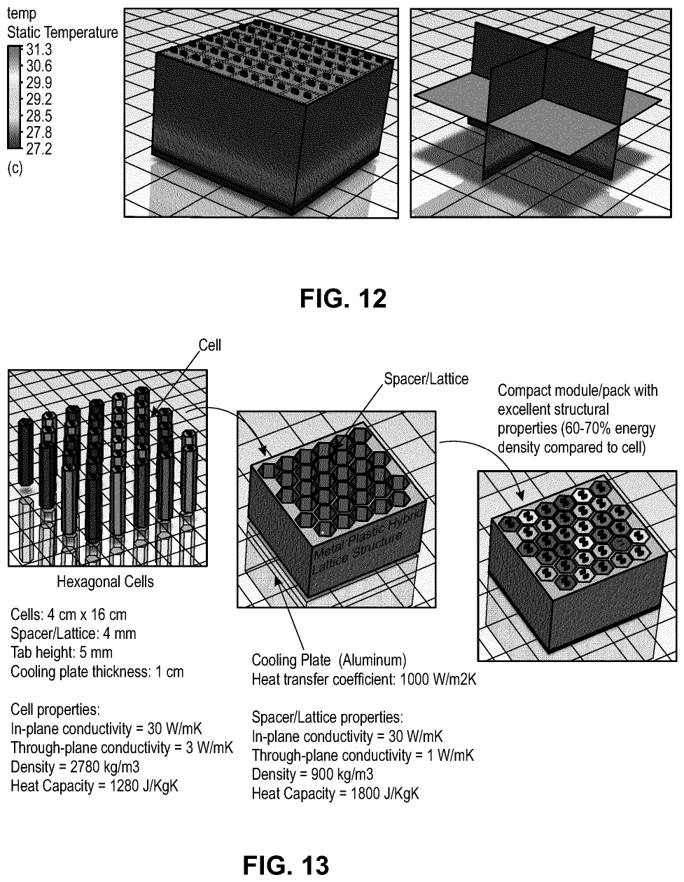

FIG. 12 shows the temperature distribution at the end of the discharge (30 minutes) with a constant 2 C discharge with the coolant temperature of 27° C. Fig. a) Contours of temperature in the battery pack; b) Temperature contours on the mid-planes. The temperature gradient at the end of the harsh 2 C discharge is very small (4° C.) over 16 cms along the height of the cell and near uniform across the plane parallel to the cooling plate. All the simulations for this example are performed using ANSYS® Fluent® 2020 R2.

### Example 4

### Example 3

### Novel Multifunctional Hexagonal Cell High Energy Dense Module/Pack

In the present invention, the cells and the module/pack are redesigned with the following considerations:
Following nature's lead to optimize materials, form, and function—cell, module, and pack are reimagined
Highest packing efficiency and energy density—100% more than conventional cell
Amenable to cell-to-pack and cell-to-skateboard
   Optimal than 4680 cylindrical or CATL prismatic cells
Very low risk as this solution fits into existing pouch cell manufacturing with minimal modifications of an existing line
No need for new chemistry
Potentially lowest cell internal resistance among all formats
Homogeneous temperature and electrical fields
   Increased cycle life
Safe discharge of cells upon abuse conditions
   Overcharge and dendrite formation
   Crash
Designed for easy disassembly and recycling
   Hexagonal cross-section cells are considered as effective (FIG. 13) with each cell of side 4 cm at 128 Wh/35 Ah (500 Wh/L). The cells have in-plane conductivity of 30 W/mK, through-plane conductivity of 3 W/mK, Density of 2780 kg/m³ and specific heat of 1280 J/KgK. A spacer present in the inventive battery pack is 4 mm thick with in-plane conductivity of 30 W/mK, through-plane conductivity of 1 K, Density of 900 kg/m³ and specific heat of 1800 J/KgK. The bottom cooling plate is representative of aluminum of thickness 1 cm with cooling channels embedded that can achieve a heat transfer coefficient of 1000 W/m²K. The loss in energy density obtained based on the inventive battery pack is only 30-40% as compared to 65-70% on reference battery packs on the electric vehicles on the market. This corresponds to almost 100% increase in the energy density.

1. A battery subpack comprising:
a plurality of cells comprising a first cell and a second cell; and
a divider that extends in a first plane and in a second plane different from the first plane, at least a portion of the divider positioned between the first cell and the second cell; and
wherein:
an in-plane thermal conductivity of the divider is between 0.1-100 watts per meter Kelvin;
an in-plane thermal conductivity of a cell of the plurality of cells is between 1-100 watts per meter Kelvin; or
a combination thereof.

2. A battery subpack comprising:
a plurality of cells including a first cell and a second cell, the plurality of cells interposed between a first side and a second side of a battery subpack, the second side opposite the first side; and
a divider that extends in a first plane and in a second plane different from the first plane, at least a portion of the divider positioned between the first cell and the second cell; and
wherein the plurality of cells are configured such that an instantaneous variation of the battery subpack is less than or equal to 10 degrees Celsius while operating at an overall temperature within a range of 20-40 degrees Celsius and while the plurality of cells unload at a C rate of 2 for 25% capacity discharge.

3. The battery subpack of claim 1, wherein the plurality of cells further includes a third cell.

4. The battery subpack of claim 3, wherein the divider includes:
a first surface configured to face the first cell and interposed between the first cell and the second cell; and
a second surface that extends from the first surface and faces the first cell, the second surface interposed between the first cell and the third cell.

5. The battery subpack of claim 4, wherein the first surface corresponds to a first divider, and the second surface corresponds to a second divider that is interlockingly coupled to the first divider.

6. A battery subpack comprising:
a plurality of cuboid cells comprising a first cuboid cell and a second cuboid cell; and
wherein the plurality of cuboid cells are positioned within a cuboid case, the cuboid case including a horizontal cross-section through the plurality of the cells where the plurality of cells comprise at least 50 percent of a total area of the horizontal cross-section.

7. The battery subpack of claim 6, wherein the plurality of cells comprise at least 80 percent of the horizontal cross-section.

8. A battery subpack comprising:
a plurality of cells including a first cell, a second cell, a first side, and a second side opposite the first side;
one or more dividers positioned between the first side and the second side, the one or more dividers extend in a first plane and in a second plane different from the first plane, at least a portion of the one or more divider positioned between the first cell and the second cell; and
a plate disposed on the second side of the plurality of cells.

9. The battery subpack of claim 8, wherein the plurality of cells further includes a third cell.

10. The battery subpack of claim 9, wherein the one or more divider includes:
a first surface configured to face the first cell and interposed between the first cell and the second cell; and
a second surface that extends from the first surface and faces the first cell, the second surface interposed between the first cell and the third cell.

11. The battery subpack of claim 1, wherein each cell of the plurality of cells is a lithium-ion battery.

12. The battery subpack of claim 1, further comprising:
a plate disposed on a second side of the plurality of cells; and
wherein the plurality of cells include and are interposed between the first side and the second side opposite the first side.

13. The battery subpack of claim 1, wherein
the divider includes a material selected from the group comprising fiber, carbon fiber, highly oriented polyolefins, a polymer, metalized polymers, and a highly conductive metal.

14. The battery subpack of claim 8, wherein:
the divider comprises a polymer; and
the divider defines a liquid channel.

15. The battery subpack of claim 8, wherein:
the plate includes a first planar surface and a second planar surface interposed between the first surface and the plurality of cells; and
the horizontal cross section is parallel to the second planar surface of the plate.

16. The battery subpack of claim 8, wherein the one or more dividers include:
a first divider having a first surface facing the first cell of the plurality of cells; and
a second divider having a second surface facing the first cell, the second surface angularly disposed relative to the first surface.

17. The battery subpack of claim 2, wherein the plurality of cells further includes a third cell.

18. The battery subpack of claim 17, wherein the divider includes:
a first surface configured to face the first cell and interposed between the first cell and the second cell; and
a second surface that extends from the first surface and faces the first cell, the second surface interposed between the first cell and the third cell.

19. The battery subpack of claim 18, wherein the first surface corresponds to a first divider, and the second surface corresponds to a second divider that is interlockingly coupled to the first divider.

20. The battery subpack of claim 2, wherein each cell of the plurality of cells is a lithium-ion battery.
